(19) United States
(12) Patent Application Publication
(10) Pub. No.: US 2026/0340657 A1
(43) Pub. Date: Oct. 29, 2026

(54) SYSTEMS AND METHODS FOR EXPERIENTIAL TRAJECTORY GOVERNANCE ACROSS MODULATED STATE-BASED ENVIRONMENTS

(71) Applicant: Joseph Michael Chandler, Mansfield, OH (US)

(72) Inventor: Joseph Michael Chandler, Mansfield, OH (US)

(21) Appl. No.: 19/653,420

(22) Filed: Apr. 21, 2026

Related U.S. Application Data
(60) Provisional application No. 63/795,507, filed on Apr. 27, 2025.

(51) Int. Cl. G06Q 30/018

(52) U.S. Cl. CPC G06Q 30/018

(57) ABSTRACT

A system and method are disclosed for supervisory governance of experiential trajectory within modulated state-based environments in which system state evolves over time. The system models experiential state as a structured representation capable of directional evolution, derives trajectory characteristics including direction, magnitude, and volatility across progression intervals, and evaluates deviation relative to one or more anchor constraints or stability envelopes that define acceptable trajectory conditions. Based on evaluated trajectory conditions, including envelope proximity, projected trajectory behavior, and volatility characteristics, the system generates bounded modulation directives and, in certain embodiments, advisory outputs associated with trajectory conditions, including based on feedforward trajectory evaluation prior to deviation, at one or more points along the trajectory, during boundary interaction, or following deviation beyond a defined stability envelope rather than solely after outcome realization. The supervisory modulation framework operates independently of underlying state-generation mechanisms and improves stability and coherence across interactive environments.

### CROSS-REFERENCE TO RELATED APPLICATIONS

This application claims the benefit of U.S. Provisional Patent Application No. 63/795,507, filed Apr. 27, 2025, entitled “NextEdge NexusEcho,” the disclosure of which is incorporated herein by reference in its entirety.

This application is also related to the inventor's other applications within the NextEdge ecosystem, including but not limited to:
U.S. patent application Ser. No. 19/458,517, filed Jan. 23, 2026, entitled “SENSESTRUCT SYSTEM FRAMEWORK AND METHOD FOR EMOTIONAL-COGNITIVE STATE STABILIZATION AND GOVERNANCE”;
U.S. Provisional Patent Application No. 63/820,453, filed Jun. 9, 2025, entitled “Emotion-Adaptive Instructional Optimization and Feedback System”;
U.S. Provisional Patent Application No. 63/893,703, filed Oct. 4, 2025, entitled “Omnipresent Data Awareness Nexus (ODAN)”;
U.S. Provisional Patent Application No. 63/975,163, filed Feb. 3, 2026, entitled “SenseUI Interface Modulation Systems for Engineering Human System Interaction Under Dynamic User Conditions”;
U.S. Provisional Patent Application No. 63/983,797, filed Feb. 16, 2026, entitled “SenseSimile ™: A Reasoning Likeness Preservation Framework.”

Each of the foregoing applications describes a distinct yet interoperable architectural component within the broader NextEdge modular ecosystem. The present application is directed specifically to experiential trajectory governance within modulated state-based environments and does not claim learner-state stabilization mechanisms, biometric emotional sensing architectures, reasoning likeness preservation frameworks, or interface control architectures disclosed in related filings.

### FIELD OF THE INVENTION

The present invention relates generally to computational systems and, more particularly, to systems and methods for governance of experiential trajectory within modulated state-based environments in which system state evolves over time.

More specifically, the invention pertains to supervisory modulation architectures configured to perform ongoing evaluation and conditioning of directional evolution of system state across trajectory progression, including prior to, during, or following experiential outcome formation, based on evaluation of emotional or other experiential signal inputs and trajectory conditions relative to defined anchor constraints associated with defined stability constraints. Such systems may be implemented across digital, interactive, simulated, communicative, rule-based, or other computational environments in which contextual, structural, behavioral, or narrative state variables evolve dynamically.

### BACKGROUND OF THE INVENTION

State-based systems are implemented across a wide range of digital and computational environments. Such systems may include interactive platforms, simulation environments, communication systems, training frameworks, media systems, and other architectures in which contextual, structural, behavioral, or narrative state variables evolve dynamically over time. The interaction process within such systems may involve one or more agents, including human agents, artificial agents, rule-based systems, autonomous systems, or combinations thereof.

In these environments, system state commonly comprises one or more evolving variables that change based on system inputs, agent interactions, environmental conditions, contextual parameters, or internal progression logic. The evolution of such state variables may follow directional pathways, gradients, or progression sequences that unfold across time or interaction cycles.

Experiential inputs, whether derived from interaction signals, contextual indicators, environmental conditions, behavioral markers, or other signal sources, may influence the evolution of system state. Such inputs may introduce directional shifts, acceleration effects, volatility gradients, or divergence tendencies within the evolving state.

Many existing systems implement reactive or adaptive adjustment mechanisms to accommodate changes in system conditions or interaction inputs. Such mechanisms may modify parameters, adjust outputs, alter sequencing, or otherwise adapt system behavior in response to detected inputs. Such mechanisms often operate after state transitions have occurred or in response to localized conditions, and may not evaluate or regulate the directional progression of state at a trajectory level prior to outcome realization across the evolving interaction.

Additionally, existing approaches generally focus on localized adjustment or reactive adaptation and may not implement a supervisory framework configured to govern overall trajectory evolution relative to defined anchor constraints or stability envelopes. Without such supervisory governance, high-variance or rapidly accelerating inputs may contribute to instability, oscillatory behavior, coherence degradation, or uncontrolled trajectory divergence within the evolving system state.

The disclosed system differs from reactive adaptation mechanisms in that it supervises the trajectory of evolving system state rather than merely adjusting outputs after state changes occur. By modeling directional state evolution, detecting deviation relative to defined anchor constraints, and applying bounded modulation at one or more points along trajectory progression, including prior to deviation, during boundary interaction, or following deviation beyond a defined stability envelope, the supervisory framework is configured to influence trajectory development throughout the interaction lifecycle.

Accordingly, there remains a need for systems and methods that model directional state evolution, evaluate deviation relative to defined anchor constraints, and apply bounded modulation according to a governing trajectory intervention policy to maintain stability, coherence, and controlled progression without replacing underlying state-generation processes.

### TABLE OF CONTENTS

The following Table of Contents is provided to assist examiner navigation through the SenseEcho specification. Given the architectural complexity of the disclosed system, this index supports efficient location of sections, figures, and appendices. The Table of Contents is informational in nature and does not define, limit, or characterize the scope of any claims or embodiments described herein.
CROSS-REFERENCE TO RELATED APPLICATIONS . . . 1
FIELD OF THE INVENTION . . . 2
BACKGROUND OF THE INVENTION . . . 2
SUMMARY OF THE INVENTION . . . 6
   Terminology and Foundational Definitions . . . 8
BRIEF SUMMARY OF THE DRAWINGS . . . 15
BRIEF DESCRIPTION OF THE DRAWINGS . . . 15
DETAILED DESCRIPTION OF THE INVENTION . . . 26
   Depiction Rules for Pathways and Internal Subsystems . . . 27
   Control and Authority Representation . . . 28
   Detailed Description of the Drawings . . . 28
   Variations and Alternatives . . . 67
   Trajectory Governance Posture Variants . . . 70
   Implementation Flexibility and Functional Equivalence . . . 71
   Component Classification Framework . . . 73
   Descriptive Naming Conventions . . . 74
   External System References . . . 75
   Architectural Expression and Line-Style Neutrality . . . 76
   Global Figure Standards and Drawing Conventions . . . 76
INDUSTRIAL APPLICABILITY . . . 78
ADVANTAGES OF THE INVENTION . . . 80
CLAIMS . . . 83
ABSTRACT . . . 89
APPENDIX A: FIGURE INDEX SUMMARY . . . 90
APPENDIX B: AUTHORITATIVE COMPONENT REGISTRY (ACR) . . . 92
APPENDIX C: COMPONENT DEFINITIONS . . . 96
APPENDIX D: ARCHITECTURAL SCOPE (NON-LIMITING) . . . 110

### LIST OF FIGURES

FIG. 1—Supervisory Modulation Framework

FIG. 2—Experiential State Modeling Architecture

FIG. 3—Trajectory Vector Engine Logic Architecture

FIG. 4—Anchor Designation and Constraint Structure

FIG. 5—Drift Detection and Volatility Analysis Flow

FIG. 6—Constraint Enforcement and Modulation Pathways

FIG. 7—Feedforward Pre-Escalation Control Architecture

FIG. 8—Bidirectional Modulation Mechanism Architecture

FIG. 9—Experiential Signal Intake and Normalization Architecture

FIG. 10—Degraded Variant Supervisory Architecture

FIG. 11—Domain-Agnostic Deployment Architecture

FIG. 12—Supervisory Interaction Boundary Architecture

FIG. 13—ODAN Interoperability Overview

FIG. 14—SNARE Recovery and Containment Architecture

FIG. 15—Experiential Trajectory Stability Envelope Model

FIG. 16—Experiential Trajectory Deviation and Post-Boundary Modulation Model

### SUMMARY OF THE INVENTION

The present invention relates to systems and methods for governance of experiential trajectory within modulated state-based environments in which experiential state evolves over time. Such environments comprise digital, interactive, simulated, communicative, rule-based, or other computational systems in which contextual, environmental, behavioral, structural, or narrative state variables evolve dynamically. The interaction process within such environments may involve one or more agents, including human agents, artificial agents, rule-based systems, autonomous systems, or combinations thereof. The invention provides a supervisory modulation framework configured to perform ongoing evaluation and to regulate directional evolution of experiential state based on evaluation of experiential signal inputs and trajectory conditions relative to one or more designated anchor constraints.

The disclosed architecture implements supervisory governance of trajectory evolution within the experiential state of a modulated environment. The framework models directional progression of experiential state, evaluates deviation relative to designated anchor constraints, and applies bounded modulation mechanisms during trajectory evolution that condition the developmental path of the evolving state. Through this supervisory governance framework, trajectory evolution may be stabilized and guided within defined stability envelopes at one or more points along trajectory progression, including prior to deviation, during boundary interaction, or following deviation beyond defined stability constraints.

In many implementations, the experiential system produces the underlying narrative or experiential environment, while the supervisory trajectory-governance framework (referred to herein as “SenseEcho”) operates to evaluate experiential state evolution relative to one or more stability envelopes. Such stability envelopes may be predefined by the experiential system, derived from narrative design constraints, dynamically derived or resolved by one or more governing systems, agent entities, or upstream processes, or otherwise determined by the architecture governing the experiential environment. SenseEcho evaluates experiential trajectory behavior relative to these envelopes and may apply modulation mechanisms according to a governing trajectory intervention policy based on trajectory conditions including envelope proximity, projected trajectory behavior, volatility characteristics, drift conditions, or other supervisory evaluation metrics.

In adaptive, reactive, or emotionally responsive systems, system state may comprise one or more evolving variables including environmental parameters, contextual conditions, agent or system behaviors, interaction dynamics, structural progression markers, content sequencing, narrative progression, and other state dimensions that unfold over time. Inputs, whether derived from user interaction, contextual signals, environmental conditions, or other signal sources, may influence such evolution. However, such systems may lack explicit trajectory-level governance capable of regulating the directional evolution of system state across trajectory progression. Absent such governance, high-variance inputs may contribute to instability, oscillatory behavior, escalation amplification, or coherence degradation within the evolving state.

The present invention introduces a trajectory governance framework that operates as a supervisory modulation system over the evolving experiential state. The framework models directional state evolution, evaluates deviation magnitude relative to defined anchor constraints, evaluates volatility characteristics, and applies bounded modulation according to a governing trajectory intervention policy to maintain trajectory coherence within defined stability envelopes. Modulation, as used herein, encompasses adaptive state adjustment, constraint enforcement, rate limiting, eligibility conditioning, escalation gating, counterbalancing injection, suppression, amplification, scheduled re-weighting, and other bounded influence mechanisms that shape trajectory evolution.

In certain embodiments, the supervisory modulation framework operates as a layered architecture comprising an input intake and normalization stage configured to receive or derive experiential signal inputs; an experiential state modeling layer configured to represent experiential state as a multi-dimensional state vector, state map, or other structured representation capable of directional evolution; and a trajectory governance layer configured to determine experiential trajectory characteristics relative to one or more designated anchor constraints.

The trajectory governance layer may include a trajectory vector engine configured to determine directional evolution, gradient magnitude, volatility characteristics, and escalation slope; a drift detection engine configured to evaluate deviation magnitude relative to anchor constraints or stability envelopes; and a constraint enforcement layer configured to apply bounded modulation to condition state evolution within defined stability envelope parameters.

In some embodiments, the framework further includes feedforward pre-escalation control configured to apply modulation prior to, in anticipation of, or in response to destabilizing divergence, stability envelope boundary conditions, cascade conditions, or projected instability. Feedforward control may be informed by acceleration indicators, volatility gradients, directional projections, projected stability envelope boundary interaction conditions, or other forward or projected trajectory characteristics. Bidirectional modulation mechanisms may be implemented to suppress destabilizing amplification while elevating stabilizing, counterbalancing, or de-escalatory vectors. In certain embodiments, modulation may be initiated prior to, at, or following interaction of the experiential trajectory with one or more stability envelope boundaries based on evaluated trajectory conditions.

The supervisory modulation framework does not replace authorial agency, user agency, identity reasoning systems, interface control systems, or underlying state-generation mechanisms. Instead, the framework governs trajectory evolution through bounded constraint enforcement while preserving the underlying processes that generate experiential state. Narrative systems, simulation systems, interactive media environments, enterprise communication systems, training systems, and other evolving experiential platforms represent non-limiting embodiments of the broader modulated state-based environment.

### Terminology and Foundational Definitions

As used herein, the following terms are provided to establish structural clarity and are not intended to be limiting unless expressly stated.

Experiential State—refers to a multi-dimensional representation of one or more evolving variables or composite variable sets within a state-based environment. Such variables or composite variable sets may include contextual conditions, environmental parameters, behavioral attributes, structural progression markers, interaction dynamics, narrative progression, content sequencing, or other state dimensions that evolve over time. An experiential state may be represented computationally as a state vector, state map, state model, or other structured representation capable of directional evolution.

As used herein, experiential state is not limited to human subjective experience and may correspond to state conditions associated with one or more agents, systems, or interaction processes, including computational, rule-based, simulated, autonomous, or hybrid environments, and may encompass state conditions distributed across or shared among multiple interacting agents or systems.

Experiential Trajectory—refers to the directional evolution of one or more experiential state dimensions across time or progression. Experiential trajectory may describe the evolving direction, magnitude, volatility, or rate of change of variables associated with the experiential state. Such trajectory characteristics may be expressed as vector direction, gradient magnitude, volatility slope, escalation rate, or other directional properties describing how experiential state variables evolve within the modulated state-based environment.

In certain implementations, experiential trajectory may be segmented into discrete phases, intervals, or evaluation windows, each of which may be independently assessed, modulated, or governed. In many implementations, experiential trajectory evolution may influence or culminate in a realized experiential outcome produced by the experiential system, without requiring the trajectory itself to deterministically define or fix such outcome.

Experiential trajectory may be evaluated and influenced across multiple phases of progression, including prior to deviation, during boundary interaction, or following deviation relative to defined stability constraints.

Experiential Outcome—refers to a realized or realizable system state, event condition, or experiential result associated with an experiential system following or arising from the evolution of one or more experiential state variables over time, including outcomes generated, resolved, or influenced by one or more external systems, agent entities, or underlying processes. An experiential outcome may represent a narrative development, system response, interaction result, simulation state transition, communication output, or other realized or emergent condition associated with the experiential environment.

In certain embodiments, the point in time at which an experiential outcome is produced, resolved, or influenced may be represented as an Experiential Outcome Boundary (3710), which marks a temporal position at which the experiential system generates, resolves, or conditions an outcome resulting from prior or ongoing trajectory evolution.

In certain implementations, experiential outcomes may be conditionally suppressed, deferred, redirected, replaced, or otherwise influenced based on trajectory conditions or supervisory control logic applied at one or more points along trajectory progression, including prior to, during, or following deviation relative to defined stability constraints.

Modulation—refers broadly to any bounded conditioning applied by a supervisory control mechanism to the evolution, direction, rate, amplitude, eligibility, or stability characteristics of an experiential state or experiential trajectory. Modulation encompasses, without limitation, adaptive adjustment, reactive correction, constraint enforcement, state eligibility determination, rate limiting, envelope-conditioned gating, suppression, amplification, scheduled re-weighting, counterbalancing injection, or other forms of conditioning or regulation that shape trajectory evolution, wherein such conditioning does not require deterministic specification of a resulting state or outcome.

Adaptive adjustment represents a subset of modulation in which modulation behavior is dynamically determined in response to evolving inputs; however, modulation is not limited to adaptive mechanisms and may include static, scheduled, conditional, or rule-based influence mechanisms.

In certain implementations, modulation may include enforcement of state eligibility conditions that determine whether a given experiential state, trajectory progression, or outcome is permitted or restricted, including suppression, delay, redirection, or other influence, based on criteria defined external to the supervisory modulation mechanism or derived from one or more governing systems or agent entities.

Modulation may be applied at one or more points along trajectory progression, including prior to deviation, during boundary interaction, or following deviation relative to defined stability constraints.

Anchor Constraint—refers to a designated reference condition, target vector, stability envelope, or other constraint construct against which experiential state evolution or experiential trajectory evolution is evaluated and governed. Anchor constraints may represent intended directionality, bounded stability ranges, structural coherence conditions, safety limits, narrative objectives, enterprise policy boundaries, or other governing references used to assess and influence trajectory progression, and may be derived from one or more potentially non-aligned, multi-source, or externally defined criteria.

Trajectory Governance—refers to supervisory evaluation and bounded modulation of experiential state evolution relative to one or more anchor constraints. Governance does not require replacement of underlying state-generation mechanisms but instead operates as a supervisory control function that conditions trajectory evolution relative to defined stability envelopes or anchor constraints, without requiring the governance mechanism to originate or determine such constraints.

Such governance may be applied at one or more points along trajectory progression, including prior to deviation, during boundary interaction, or following deviation relative to defined stability constraints.

Stability Envelope (3712)—refers to a conceptual stability region, boundary condition, or tolerance construct representing a region within which experiential state evolution may be considered coherent, bounded, or acceptable relative to designated anchor constraints. Such constraints may be derived from one or more potentially non-aligned or multi-source criteria. The stability envelope functions as a supervisory reference construct used for evaluating and influencing experiential trajectory evolution over time and may be static, dynamically adjusted, learned, or redefined based on observed system behavior, contextual conditions, or policy-driven adaptation.

The envelope may reflect experiential constraints established by the governing experiential system, narrative design parameters, environmental conditions, or other architecture-level constraints that may be internal to or external from the supervisory modulation framework, including criteria defined, influenced, or resolved by one or more external systems or agent entities.

Determination of whether and when modulation, constraint enforcement, or other supervisory responses are applied relative to the stability envelope may be governed by a Trajectory Intervention Policy or other supervisory control logic, and may occur at one or more points along trajectory progression, including prior to boundary approach, during boundary interaction, or following deviation beyond the stability envelope, where such deviation is determined relative to the defined stability envelope rather than by originating the definition of the envelope itself.

Envelope Boundary-refers to a limit condition or delimiting surface associated with a stability envelope that marks a transition region between experiential trajectory states considered acceptable within the envelope and states that may be considered outside the envelope. Envelope boundaries may define upper, lower, or multidimensional limits of the stability envelope and may serve as reference conditions used by supervisory evaluation and control logic when assessing experiential trajectory conditions.

Such boundaries may be used to evaluate, anticipate, or respond to trajectory conditions approaching, interacting with, or exceeding the stability envelope, with supervisory responses such as modulation or constraint enforcement being determined according to the governing Trajectory Intervention Policy.

Trajectory Intervention Policy—refers to a supervisory determination framework that governs when and how modulation or constraint enforcement is initiated, adjusted, or applied in response to or based on experiential trajectory conditions relative to one or more stability envelope boundaries or anchor parameters, wherein such determination is performed relative to stability criteria or anchor parameters that may be defined external to the supervisory mechanism or derived from one or more governing systems or agent entities.

A trajectory intervention policy may define conditions under which modulation is applied prior to, at, or following interaction with one or more stability envelope boundaries or anchor parameters, or according to dynamically adjusted sensitivity criteria based on trajectory slope, volatility characteristics, escalation acceleration, persistence duration, projected trajectory behavior, or other supervisory evaluation metrics, without requiring deterministic specification of a resulting state or outcome.

Drift—refers to deviation of experiential state evolution or experiential trajectory from a designated anchor constraint or stability envelope, which may be measurable, inferred, or otherwise determined based on comparative or forward trajectory analysis. Drift may be directional, cumulative, acceleration-based, volatility-based, threshold-relative, or otherwise characterized through comparative or projected state analysis, and may correspond to deviation associated with human, artificial, or hybrid agent entities, including behavioral, computational, or simulated state conditions, where such deviation is determined relative to defined anchor constraints or stability envelopes rather than by originating such constraints.

Volatility—refers to the magnitude, rate, acceleration, or instability characteristics of experiential state change or experiential trajectory evolution. Volatility may be measured or inferred across one or more dimensions and may inform, influence, or determine modulation intensity, timing, or application based on observed or projected trajectory behavior, and may correspond to characteristics associated with human, artificial, or hybrid agent entities, including behavioral, computational, or simulated state conditions.

Feedforward Control—refers to pre-escalation modulation mechanisms that apply bounded modulation prior to, in advance of, or in anticipation of destabilizing divergence, stability envelope boundary conditions, cascade conditions, or projected instability based on forward trajectory assessment, without requiring deterministic prediction or certainty of a resulting state or outcome.

Feedforward control may be informed by acceleration indicators, volatility gradients, directional projections, projected stability envelope boundary interaction conditions, or other forward or projected trajectory characteristics, wherein such characteristics are evaluated relative to stability criteria or anchor constraints that may be defined external to the supervisory mechanism.

Feedforward control represents a mode of supervisory modulation that operates based on projected trajectory behavior and may be applied in conjunction with or independently from modulation applied during or following trajectory deviation.

Agent Entity (2530)—represents one or more participating entities within the interaction process, including human agents, artificial agents, rule-based systems, autonomous systems, or combinations thereof, capable of generating, influencing, observing, or responding to experiential signals within the modulated state-based environment, and may include one or more interacting or coordinated agents within a shared or distributed interaction context.

### BRIEF SUMMARY OF THE DRAWINGS

The drawings associated with this disclosure present an architectural framework of a supervisory experiential trajectory governance system configured to evaluate and govern directional evolution of experiential state within modulated state-based environments. Such environments may involve one or more agents, including human agents, artificial agents, rule-based systems, autonomous systems, or combinations thereof. The figures illustrate representative systems, processes, signals, control boundaries, and modulation layers that collectively support evaluation of trajectory conditions relative to defined anchor constraints and application of bounded trajectory modulation mechanisms at one or more points along trajectory progression.

The drawings emphasize structural relationships, supervisory control pathways, and boundary interaction logic rather than implementation-specific details, and are intended to provide visual context for the trajectory-governance concepts described herein. The illustrated architectures support supervisory evaluation and modulation prior to deviation, during boundary interaction, or following deviation relative to defined stability constraints.

### BRIEF DESCRIPTION OF THE DRAWINGS

The following brief descriptions provide a high-level overview of what each figure depicts. These summaries identify the principal components shown in each drawing and outline the structural scope of the illustrated architecture without detailing operational mechanics. The same figures are discussed in greater depth in the Detailed Description of the Invention, including the Detailed Description of the Drawings, where functional behavior, supervisory logic, and internal interactions are explained.

The brief descriptions are intended solely to orient the reader to what is shown in each figure and are not limiting in scope. Elements may be simplified or shown schematically for clarity, and reference numerals correspond to component identifiers used throughout this disclosure.

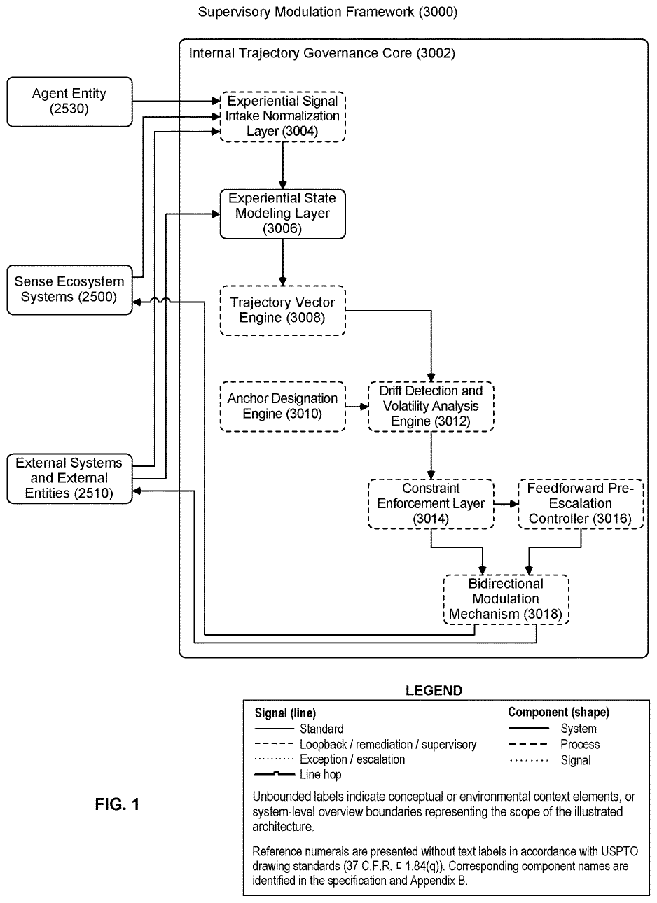

### Supervisory Modulation Framework (FIG. 1)

FIG. 1 illustrates the Supervisory Modulation Framework (3000), which presents a high-level architectural representation of a trajectory-governance system configured to operate across modulated state-based environments. The figure defines the Internal Trajectory Governance Core (3002) as a bounded subsystem within the Supervisory Modulation Framework (3000), alongside representative external entities including the Agent Entity (2530), Sense Ecosystem Systems (2500), and External Systems and External Entities (2510). Within the Internal Trajectory Governance Core (3002), the Experiential Signal Intake Normalization Layer (3004), the Experiential State Modeling Layer (3006), the Trajectory Vector Engine (3008), the Anchor Designation Engine (3010), the Drift Detection and Volatility Analysis Engine (3012), the Constraint Enforcement Layer (3014), the Feedforward Pre-Escalation Controller (3016), and the Bidirectional Modulation Mechanism (3018) are depicted as coordinated components that collectively support supervisory evaluation and modulation of trajectory progression. Arrows and signal pathways in this figure illustrate the structural relationships through which experiential inputs may be received, experiential state is represented, and trajectory characteristics are evaluated relative to defined anchor constraints, with bounded modulation applied at one or more points along trajectory progression across internal and external system interfaces, thereby establishing the core trajectory-governance structure of the system.

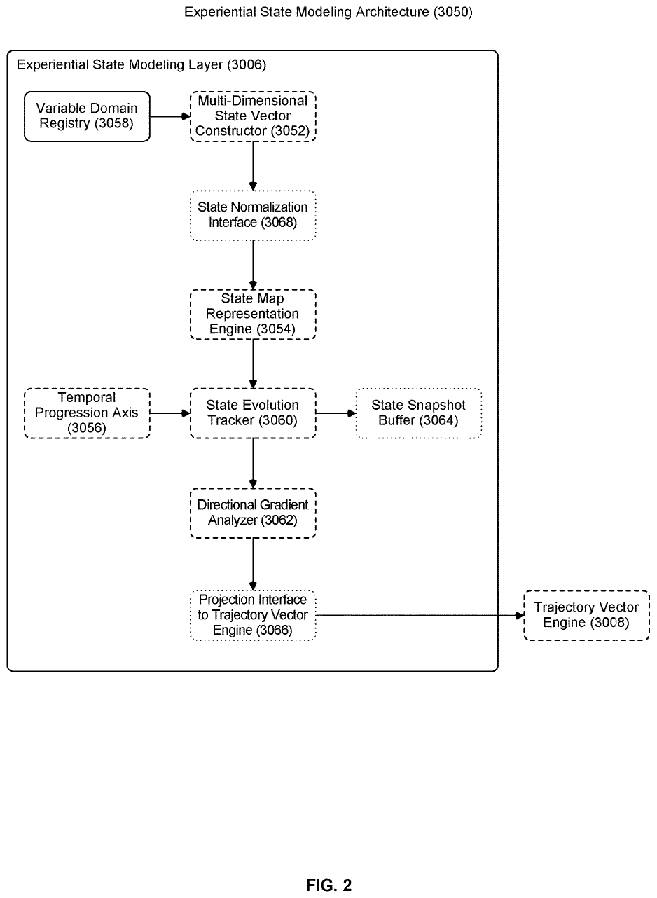

### Experiential State Modeling Architecture (FIG. 2)

FIG. 2 illustrates the Experiential State Modeling Architecture (3050), which presents the architectural organization of the Experiential State Modeling Layer (3006) and its internal components configured to construct, normalize, represent, and track evolving experiential state across trajectory progression. The figure defines the Variable Domain Registry (3058) providing domain definitions to the Multi-Dimensional State Vector Constructor (3052), which generates state vectors that are conditionable by the State Normalization Interface (3068) prior to representation by the State Map Representation Engine (3054). The Temporal Progression Axis (3056) is depicted as providing temporal conditioning input to the State Evolution Tracker (3060), which receives mapped state data from the State Map Representation Engine (3054) and tracks state evolution over time. The State Evolution Tracker (3060) provides outputs to the Directional Gradient Analyzer (3062) and the State Snapshot Buffer (3064), enabling both directional characterization and state capture. The Directional Gradient Analyzer (3062) provides structured projection input through the Projection Interface to Trajectory Vector Engine (3066), which in turn provides structured output to the Trajectory Vector Engine (3008). Arrows and signal pathways depicted in this figure illustrate the architectural relationships through which experiential state is constructed, temporally conditioned, evaluated for directional characteristics, and projected to downstream trajectory-governance mechanisms.

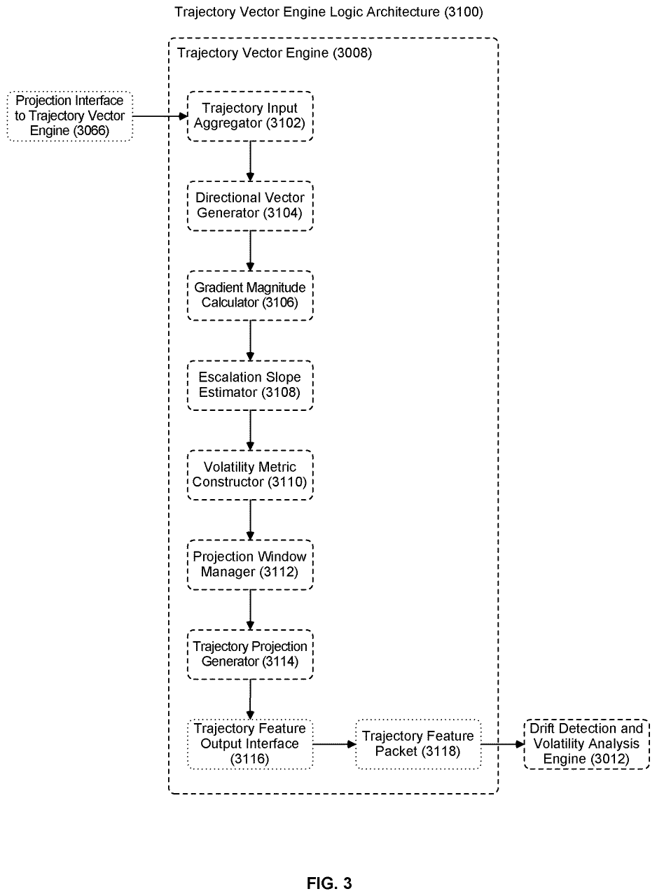

### Trajectory Vector Engine Logic Architecture (FIG. 3)

FIG. 3 illustrates the Trajectory Vector Engine Logic Architecture (3100), depicting the internal functional structure of the Trajectory Vector Engine (3008) and its relationship to upstream modeling inputs and downstream analytical components. The figure defines the Projection Interface to Trajectory Vector Engine (3066) as providing input to a Trajectory Input Aggregator (3102), followed by coordinated computational elements including the Directional Vector Generator (3104), Gradient Magnitude Calculator (3106), Escalation Slope Estimator (3108), Volatility Metric Constructor (3110), Projection Window Manager (3112), and Trajectory Projection Generator (3114). The trajectory characteristics generated by these elements are provided through the Trajectory Feature Output Interface (3116) and encapsulated within a Trajectory Feature Packet (3118), which is provided to the Drift Detection and Volatility Analysis Engine (3012). Arrows in the figure illustrate the structural relationships through which trajectory characteristics are derived, evaluated, and provided to downstream supervisory analysis components within the trajectory-governance framework.

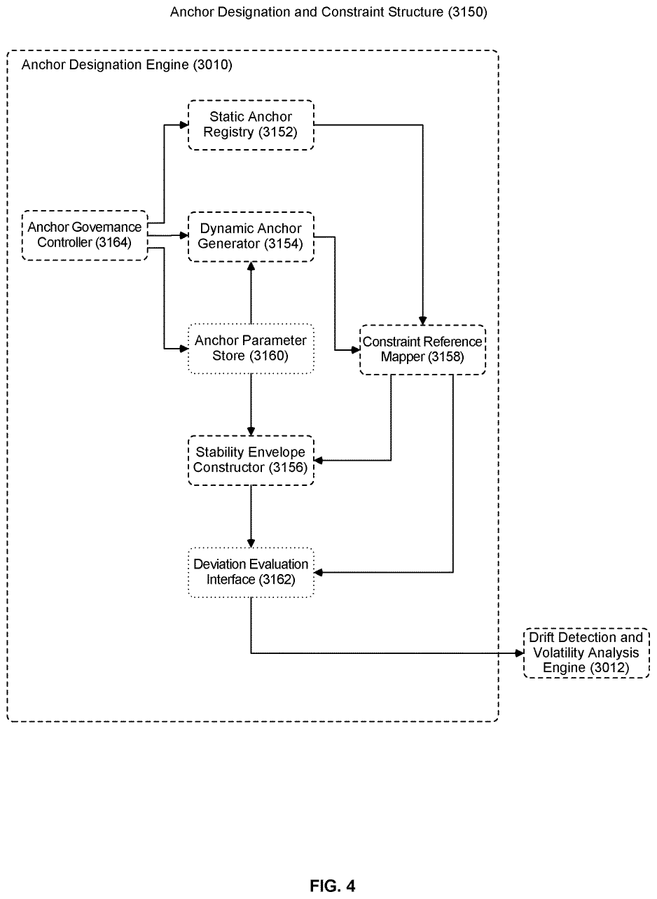

### Anchor Designation and Constraint Structure (FIG. 4)

FIG. 4 illustrates the Anchor Designation and Constraint Structure (3150), depicting the internal functional structure of the Anchor Designation Engine (3010) and its relationship to downstream analytical components. The figure defines the Anchor Governance Controller (3164) as governing anchor selection and parameter conditioning across the Static Anchor Registry (3152), the Dynamic Anchor Generator (3154), and the Anchor Parameter Store (3160). Anchor definitions are processed through the Constraint Reference Mapper (3158) and provided to the Stability Envelope Constructor (3156) and the Deviation Evaluation Interface (3162), which defines stability boundaries for deviation assessment. The anchor references and envelope parameters are provided through the Deviation Evaluation Interface (3162) to the Drift Detection and Volatility Analysis Engine (3012). Arrows in the figure illustrate the structural relationships through which anchor designation, constraint mapping, and envelope construction are coordinated and provided to downstream supervisory analysis components within the trajectory-governance framework.

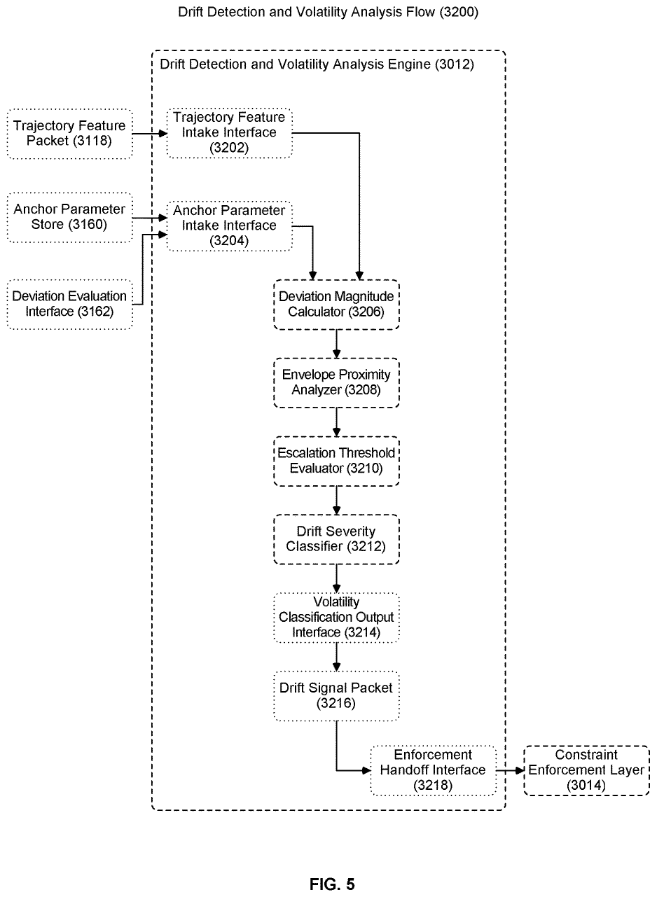

### Drift Detection and Volatility Analysis Flow (FIG. 5)

FIG. 5 illustrates the Drift Detection and Volatility Analysis Flow (3200), which depicts the internal functional structure of the Drift Detection and Volatility Analysis Engine (3012) configured to evaluate deviation magnitude, envelope proximity, and escalation conditions relative to established anchor parameters. The figure defines the Trajectory Feature Packet (3118) and anchor-related inputs from the Anchor Parameter Store (3160) and Deviation Evaluation Interface (3162) as being received by the Trajectory Feature Intake Interface (3202) and Anchor Parameter Intake Interface (3204), respectively. These inputs are processed by coordinated analytical components including the Deviation Magnitude Calculator (3206), the Envelope Proximity Analyzer (3208), the Escalation Threshold Evaluator (3210), and the Drift Severity Classifier (3212), which collectively support volatility classification. The Volatility Classification Output Interface (3214) generates a Drift Signal Packet (3216), which is provided through the Enforcement Handoff Interface (3218) to the Constraint Enforcement Layer (3014). Arrows and signal pathways depicted in this figure illustrate the structural relationships through which experiential trajectory deviation is quantified, classified, and provided to downstream supervisory enforcement components within the trajectory-governance framework.

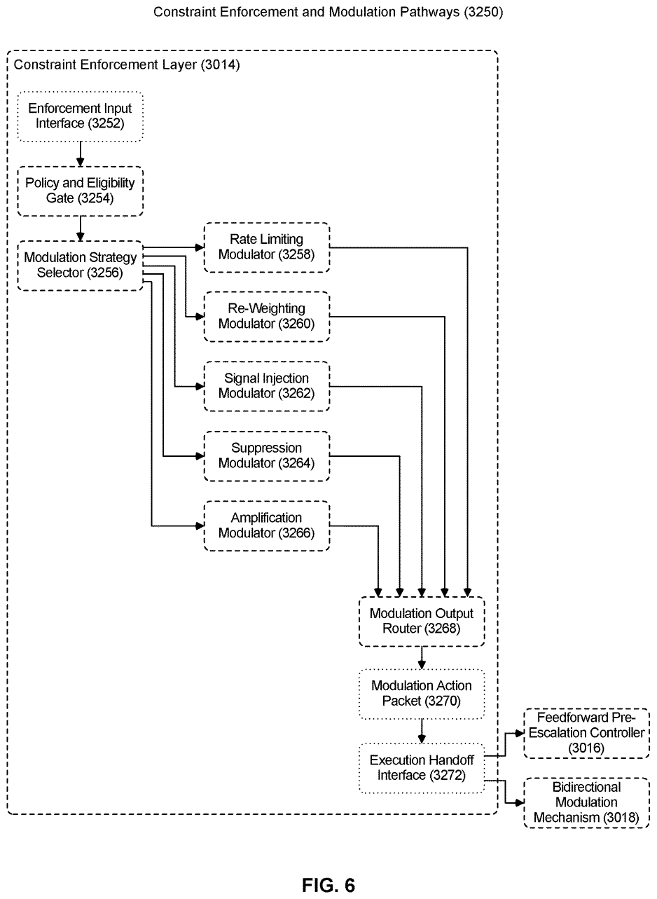

### Constraint Enforcement and Modulation Pathways (FIG. 6)

FIG. 6 illustrates the Constraint Enforcement and Modulation Pathways (3250), which depicts the internal functional structure of the Constraint Enforcement Layer (3014) configured to evaluate enforcement eligibility, determine modulation strategies, and provide structured modulation actions to downstream execution mechanisms. The figure defines enforcement inputs as being received by the Enforcement Input Interface (3252), processed through the Policy and Eligibility Gate (3254), and evaluated by the Modulation Strategy Selector (3256), which may engage one or more modulation mechanisms including the Rate Limiting Modulator (3258), Re-Weighting Modulator (3260), Signal Injection Modulator (3262), Suppression Modulator (3264), and Amplification Modulator (3266). Outputs associated with the engaged modulation mechanisms are provided through the Modulation Output Router (3268), encapsulated within a Modulation Action Packet (3270), and provided through the Execution Handoff Interface (3272) to the Feedforward Pre-Escalation Controller (3016) and/or the Bidirectional Modulation Mechanism (3018). Arrows and signal pathways depicted in this figure illustrate the structural relationships through which enforcement determinations are translated into structured modulation actions for downstream execution within the trajectory-governance framework.

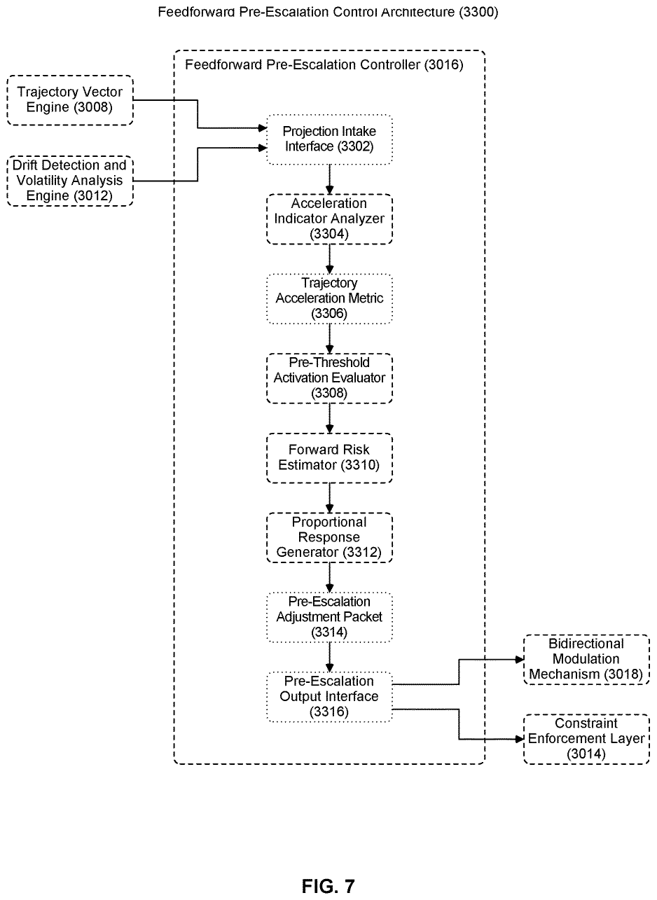

### Feedforward Pre-Escalation Control Architecture (FIG. 7)

FIG. 7 illustrates the Feedforward Pre-Escalation Control Architecture (3300), which depicts the internal functional structure of the Feedforward Pre-Escalation Controller (3016) configured to evaluate forward trajectory indicators and generate anticipatory modulation responses based on projected trajectory conditions, including conditions prior to escalation thresholds. The figure defines projection and drift indicators as being received from the Trajectory Vector Engine (3008) and the Drift Detection and Volatility Analysis Engine (3012) through the Projection Intake Interface (3302), and processed by coordinated analytical components including the Acceleration Indicator Analyzer (3304), which produces a Trajectory Acceleration Metric (3306), the Pre-Threshold Activation Evaluator (3308), the Forward Risk Estimator (3310), and the Proportional Response Generator (3312), which produces a Pre-Escalation Adjustment Packet (3314). The packet is provided through the Pre-Escalation Output Interface (3316) to the Bidirectional Modulation Mechanism (3018) and/or the Constraint Enforcement Layer (3014). Arrows and signal pathways depicted in this figure illustrate the structural relationships through which forward trajectory indicators are evaluated and used to initiate or influence anticipatory modulation actions based on projected trajectory behavior within the trajectory-governance framework.

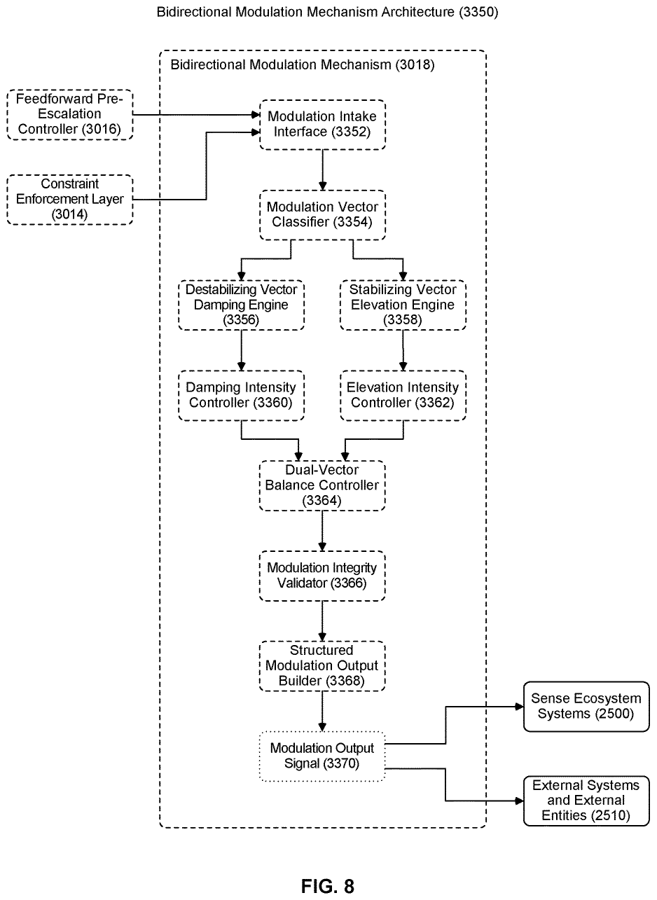

### Bidirectional Modulation Mechanism Architecture (FIG. 8)

FIG. 8 illustrates the Bidirectional Modulation Mechanism Architecture (3350), which defines the internal functional structure of the Bidirectional Modulation Mechanism (3018). The figure depicts the Feedforward Pre-Escalation Controller (3016) and the Constraint Enforcement Layer (3014) as providing control inputs to the Modulation Intake Interface (3352). The Modulation Intake Interface (3352) provides modulation directives to the Modulation Vector Classifier (3354), which evaluates the incoming control signals and classifies them as destabilizing or stabilizing modulation vectors. Destabilizing vectors are processed through the Destabilizing Vector Damping Engine (3356) and associated Damping Intensity Controller (3360), while stabilizing vectors are processed through the Stabilizing Vector Elevation Engine (3358) and Elevation Intensity Controller (3362). The modulation adjustments associated with these vectors are coordinated at the Dual-Vector Balance Controller (3364), which manages the combined influence of damping and elevation responses. The balanced modulation output is validated by the Modulation Integrity Validator (3366) and formatted by the Structured Modulation Output Builder (3368) into a Modulation Output Signal (3370). The Modulation Output Signal (3370) is provided to Sense Ecosystem Systems (2500) and External Systems and External Entities (2510). Arrows and signal pathways illustrated in this figure depict the structural relationships through which modulation directives are classified, balanced, validated, and delivered to affected systems within the trajectory-governance framework.

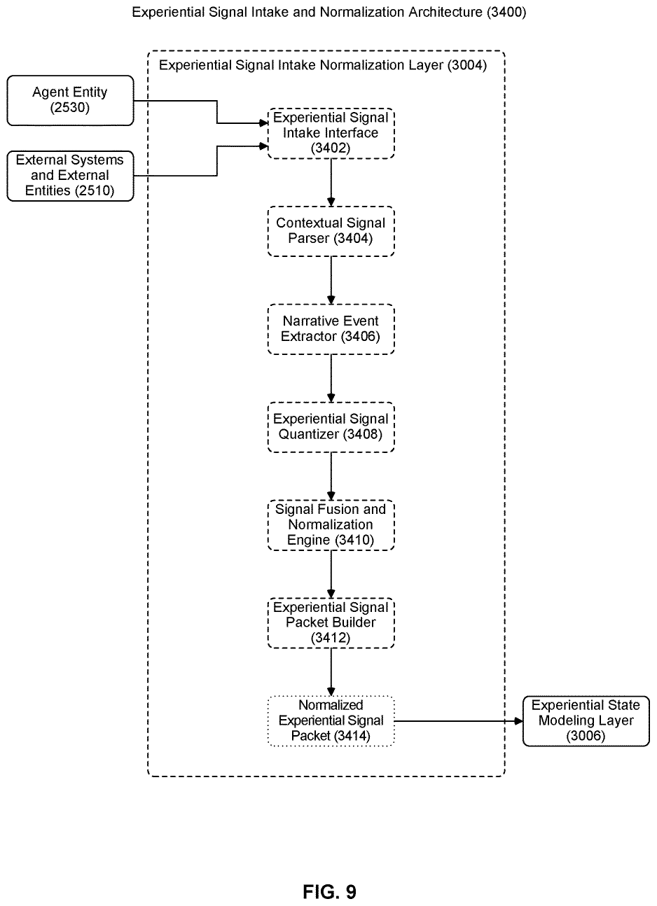

### Experiential Signal Intake and Normalization Architecture (FIG. 9)

FIG. 9 illustrates the Experiential Signal Intake and Normalization Architecture (3400), which defines the internal functional structure of the Experiential Signal Intake Normalization Layer (3004). The Experiential Signal Intake Normalization Layer (3004) receives experiential inputs originating from an Agent Entity (2530) and External Systems and External Entities (2510), and processes and normalizes those inputs into structured experiential signal packets suitable for downstream modeling operations. Incoming signals are received by the Experiential Signal Intake Interface (3402), which provides the signals to coordinated processing components including the Contextual Signal Parser (3404) for contextual interpretation, the Narrative Event Extractor (3406) for identifying narrative-relevant events or interaction elements, the Experiential Signal Quantizer (3408) for generating quantifiable signal representations, and the Signal Fusion and Normalization Engine (3410) for merging and normalizing signal inputs into a consistent signal structure. The normalized signals are provided to the Experiential Signal Packet Builder (3412), which constructs a structured experiential signal packet. The resulting Normalized Experiential Signal Packet (3414) is provided to the Experiential State Modeling Layer (3006) for downstream state modeling and trajectory evaluation. Arrows and signal pathways depicted in this figure illustrate the structural relationships through which experiential inputs are interpreted, quantified, normalized, and provided to downstream modeling components within the trajectory-governance framework.

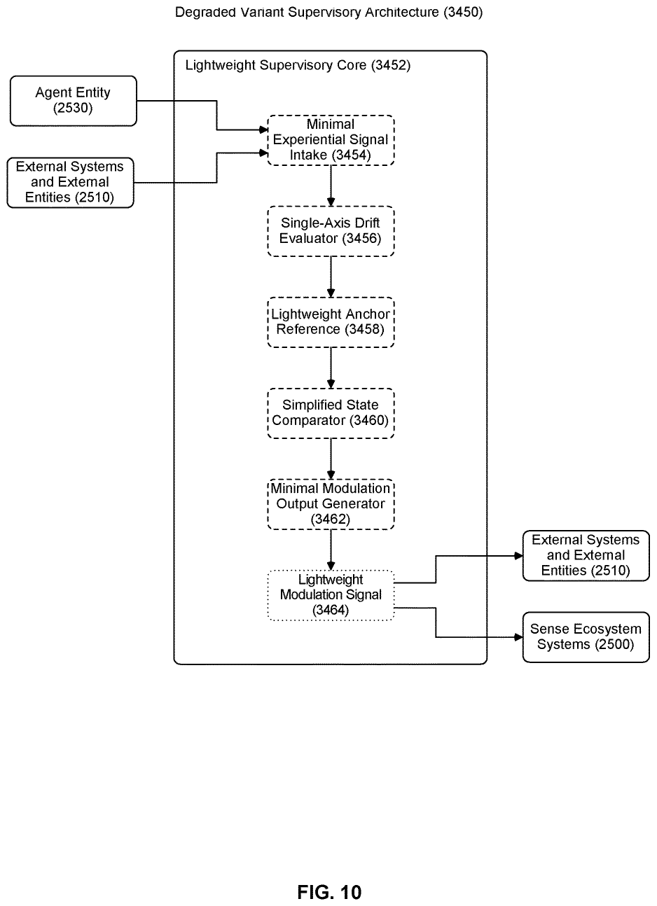

### Degraded Variant Supervisory Architecture (FIG. 10)

FIG. 10 illustrates the Degraded Variant Supervisory Architecture (3450), which depicts a simplified supervisory architecture configured to perform reduced experiential drift evaluation and modulation generation using a Lightweight Supervisory Core (3452). The figure defines experiential inputs originating from an Agent Entity (2530) and External Systems and External Entities (2510) as being received by the Minimal Experiential Signal Intake (3454), which provides the received inputs to the Single-Axis Drift Evaluator (3456) for simplified drift evaluation. The evaluated drift indicators are compared against a reference condition maintained by the Lightweight Anchor Reference (3458), and the resulting comparison state is evaluated by the Simplified State Comparator (3460). Based on detected deviation conditions, the Simplified State Comparator (3460) provides input to the Minimal Modulation Output Generator (3462), which produces a Lightweight Modulation Signal (3464). The Lightweight Modulation Signal (3464) is provided to External Systems and External Entities (2510) and Sense Ecosystem Systems (2500). Arrows and signal pathways illustrated in this figure depict the structural relationships through which simplified experiential inputs are evaluated, compared against anchor conditions, and used to generate lightweight modulation responses within the trajectory-governance framework.

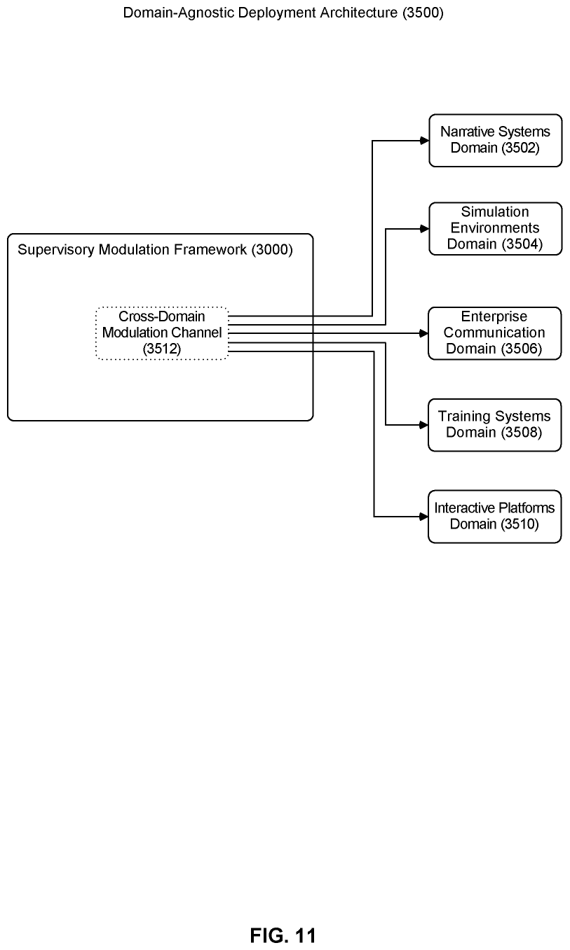

### Domain-Agnostic Deployment Architecture (FIG. 11)

FIG. 11 illustrates the Domain-Agnostic Deployment Architecture (3500), which depicts representative operational environments in which the Supervisory Modulation Framework (3000) may be deployed to provide trajectory governance and modulation control across multiple classes of interactive systems. The figure defines supervisory outputs from the Supervisory Modulation Framework (3000) as being provided through the Cross-Domain Modulation Channel (3512), which provides structured modulation signals to representative deployment domains including, without limitation, the Narrative Systems Domain (3502), Simulation Environments Domain (3504), Enterprise Communication Domain (3506), Training Systems Domain (3508), and Interactive Platforms Domain (3510). Each domain corresponds to a distinct operational environment in which experiential inputs, interaction dynamics, or communication flows may be influenced by supervisory modulation directives generated by the framework. Arrows and signal pathways illustrated in this figure depict the structural relationships through which supervisory modulation outputs are propagated across heterogeneous deployment domains within a common trajectory-governance architecture.

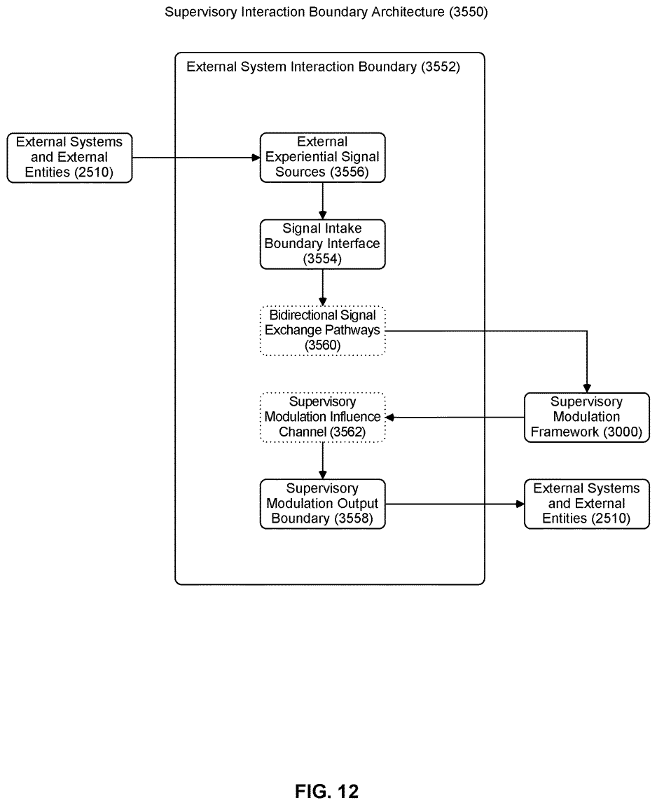

### Supervisory Interaction Boundary Architecture (FIG. 12)

FIG. 12 illustrates the Supervisory Interaction Boundary Architecture (3550), which defines the interaction boundary through which the Supervisory Modulation Framework (3000) exchanges experiential signals and supervisory modulation directives with external operational environments. The figure depicts an External System Interaction Boundary (3552) that delineates the supervisory processing environment from external systems capable of generating experiential signals or receiving supervisory modulation directives. Experiential inputs originating from External Systems and External Entities (2510) are represented as External Experiential Signal Sources (3556), which provide experiential signals to the Signal Intake Boundary Interface (3554). The Signal Intake Boundary Interface (3554) provides received signals to the Bidirectional Signal Exchange Pathways (3560), which provide experiential signal information to the Supervisory Modulation Framework (3000) for supervisory trajectory evaluation and modulation processing. Supervisory modulation directives generated by the Supervisory Modulation Framework (3000) are provided through the Supervisory Modulation Influence Channel (3562), which provides modulation influence signals to the Supervisory Modulation Output Boundary (3558). The Supervisory Modulation Output Boundary (3558) provides an outbound interface through which structured modulation outputs may be provided to External Systems and External Entities (2510). Arrows and signal pathways illustrated in this figure depict the structural relationships through which experiential signals and supervisory modulation directives are exchanged across the interaction boundary within the trajectory-governance framework.

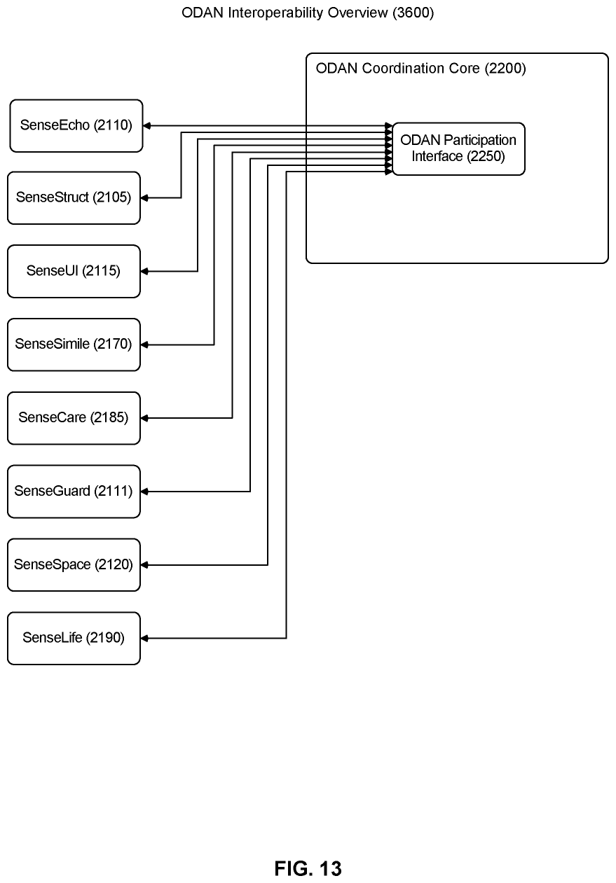

### ODAN Interoperability Overview (FIG. 13)

FIG. 13 illustrates the ODAN Interoperability Overview (3600), which defines the structural interoperability relationship between multiple Sense Ecosystem Systems (2500) and the ODAN Coordination Core (2200). The figure defines representative systems including SenseEcho (2110), SenseStruct (2105), SenseUI (2115), SenseSimile (2170), SenseCare (2185), SenseGuard (2111), SenseSpace (2120), and SenseLife (2190) as interfacing with the ODAN Coordination Core (2200) through the ODAN Participation Interface (2250). The ODAN Participation Interface (2250) is depicted as the standardized exchange boundary through which participating systems provide and receive scope-limited metadata while remaining independently governed. The ODAN Coordination Core (2200) is illustrated as the coordination environment configured to facilitate metadata synchronization among participating systems without governing their internal operations. Arrows and signal pathways illustrated in this figure depict the structural relationships through which participating systems exchange metadata signals through the ODAN Participation Interface (2250) and receive coordinated synchronization outputs from the ODAN Coordination Core (2200).

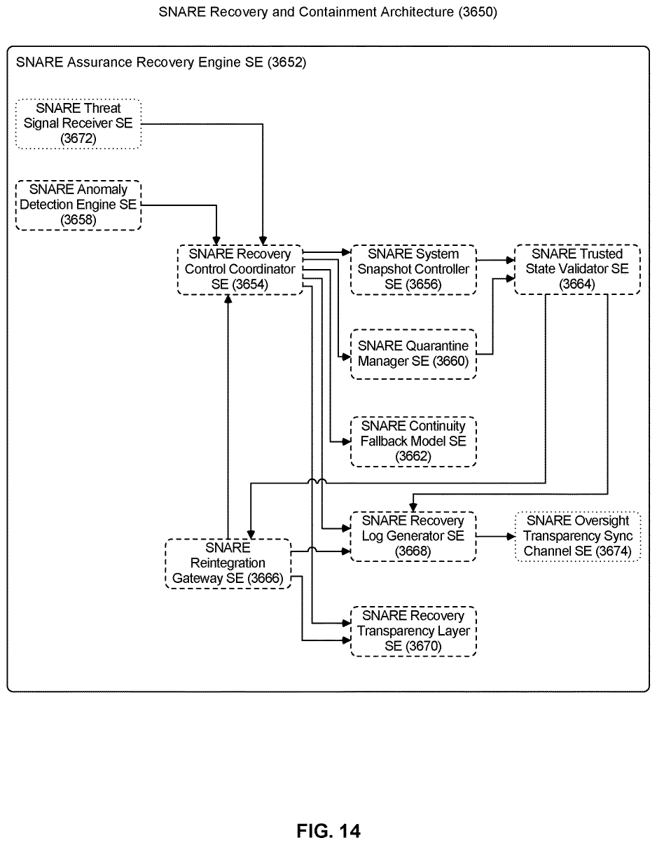

### SNARE Recovery and Containment Architecture (FIG. 14)

FIG. 14 illustrates the SNARE Recovery and Containment Architecture (3650), which depicts the recovery and containment infrastructure of the SNARE Assurance Recovery Engine SE (3652), configured to coordinate containment, rollback, continuity preservation, validation, reintegration, and transparency reporting during recovery events. The figure defines the SNARE Recovery Control Coordinator SE (3654) as receiving upstream triggers from the SNARE Threat Signal Receiver SE (3672) and the SNARE Anomaly Detection Engine SE (3658), and coordinating recovery actions across containment and recovery components including the SNARE Quarantine Manager SE (3660), the SNARE System Snapshot Controller SE (3656), and the SNARE Continuity Fallback Model SE (3662). Validation and restoration functions are supported by the SNARE Trusted State Validator SE (3664) and the SNARE Reintegration Gateway SE (3666), while transparency and oversight are supported by the SNARE Recovery Log Generator SE (3668), the SNARE Recovery Transparency Layer SE (3670), and the SNARE Oversight Transparency Sync Channel SE (3674). Arrows and signal pathways illustrated in the figure depict the structural relationships through which threat or anomaly signals are used to initiate containment procedures, coordinate recovery actions, and support validation, reintegration, and transparency reporting within the SNARE Assurance Recovery Engine SE (3652).

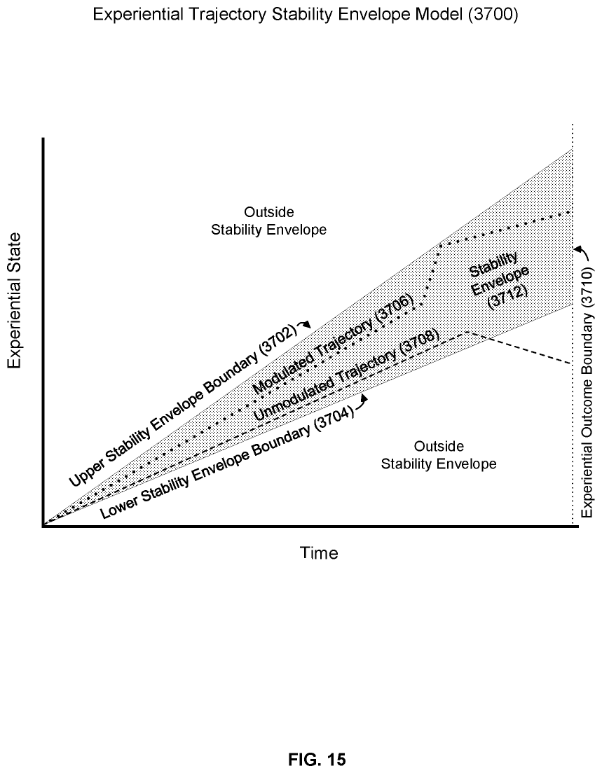

### Experiential Trajectory Stability Envelope Model (FIG. 15)

FIG. 15 illustrates the Experiential Trajectory Stability Envelope Model (3700), which depicts a conceptual supervisory evaluation model for evaluating experiential trajectory evolution relative to a stability envelope over time. The figure shows an experiential trajectory evolving along an experiential state axis relative to a temporal progression axis (time), with the Stability Envelope (3712) represented as a bounded region defined by an Upper Stability Envelope Boundary (3702) and a Lower Stability Envelope Boundary (3704). The figure further illustrates a Modulated Trajectory (3706) and an Unmodulated Trajectory (3708), representing comparative trajectory paths through which supervisory modulation may influence experiential trajectory evolution relative to the stability envelope. The Experiential Outcome Boundary (3710) is depicted as a temporal position at which the experiential system produces a realized experiential outcome following prior trajectory evolution. Visual elements within the figure illustrate how trajectory conditions may remain within the stability envelope or diverge outside the stability envelope over time, and how supervisory modulation may influence trajectory evolution at one or more points along trajectory progression, including prior to the Experiential Outcome Boundary (3710).

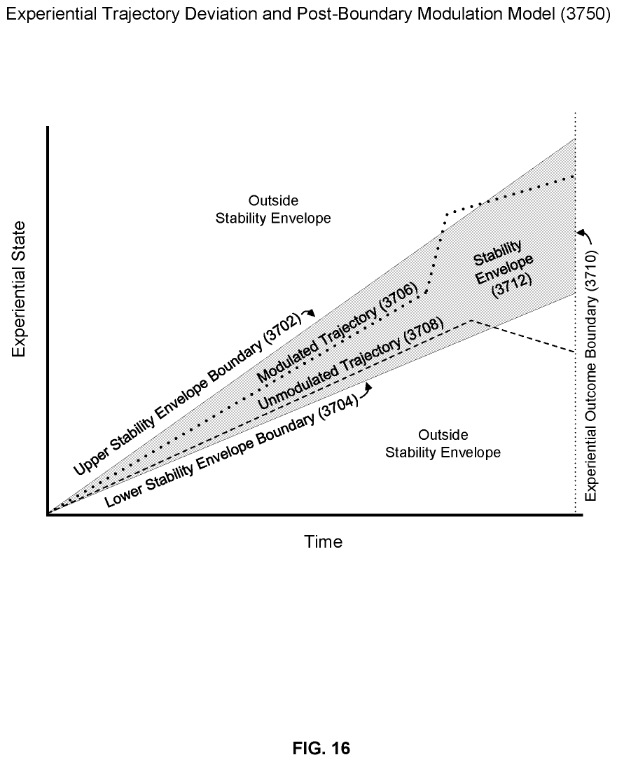

### Experiential Trajectory Deviation and Post-Boundary Modulation Model (FIG. 16)

FIG. 16 illustrates the Experiential Trajectory Deviation and Post-Boundary Modulation Model (3750), which depicts a conceptual supervisory evaluation model for evaluating experiential trajectory behavior in conditions where the trajectory deviates outside a stability envelope. The figure shows an experiential trajectory evolving along an experiential state axis relative to a temporal progression axis (time), with the Stability Envelope (3712) represented as a bounded region defined by an Upper Stability Envelope Boundary (3702) and a Lower Stability Envelope Boundary (3704). The figure further illustrates a Modulated Trajectory (3706) and an Unmodulated Trajectory (3708), representing comparative trajectory paths through which supervisory modulation may influence experiential trajectory evolution following deviation beyond the stability envelope. The Experiential Outcome Boundary (3710) is depicted as a temporal position at which the experiential system produces a realized experiential outcome following prior trajectory evolution. Visual elements within the figure illustrate how trajectory conditions may diverge outside the stability envelope and how supervisory modulation may influence trajectory behavior at one or more points along trajectory progression, including during or following interaction with the stability envelope boundaries.

### DETAILED DESCRIPTION OF THE INVENTION

The following detailed description provides an explanation of the SenseEcho Supervisory Modulation Framework and its integrated trajectory-governance components. The figures presented herein illustrate representative embodiments of the SenseEcho architecture and its supervisory interactions across modulated state-based environments. Graphical conventions such as shape type, boundary style, and signal line format (for example, solid, dashed, or dotted) are used for representational clarity and do not imply structural or implementation limitations. References to systems, processes, signals, external entities, or architectural layers are functional designations and may be implemented in any equivalent software, hardware, distributed, or hybrid configuration. Component labels, including numerals and descriptive titles, are provided for traceability and do not prescribe execution order, interface method, physical arrangement, or deployment topology.

Equivalent logical structures, signal interconnects, modeling approaches, constraint mechanisms, and modulation strategies, including merged, distributed, reduced, or functionally simplified variants that achieve substantially similar trajectory-governance and stability-preservation behavior, are considered within the scope of the invention. This includes implementations that consolidate or omit particular analytical layers, drift evaluation stages, or enforcement pathways while maintaining supervisory trajectory conditioning relative to defined anchor constraints or stability envelopes.

The SenseEcho architecture operates as a supervisory trajectory-governance layer over evolving experiential state environments. The system models experiential state evolution, derives directional trajectory characteristics, evaluates deviation relative to defined anchor constraints or stability envelopes, and applies bounded modulation mechanisms to condition trajectory progression. In environments lacking such supervisory trajectory governance, evolving state conditions may exhibit unbounded drift, escalation amplification, or instability under certain conditions. The framework may incorporate feedforward pre-escalation control and bidirectional modulation strategies to regulate acceleration, divergence magnitude, or amplification dynamics without replacing underlying state-generation processes.

The description proceeds in alignment with FIGS. 1 through 16 and reflects a supervisory lifecycle in which experiential signals may be received or derived, experiential state may be modeled, trajectory characteristics may be computed, deviation relative to anchor constraints may be evaluated, constraint logic may be applied, and bounded modulation mechanisms may condition state evolution at one or more points along trajectory progression. Each subsection anchors specific mechanisms to concrete components and signal pathways to support system and method claims, including cross-component timing relationships, deviation thresholds, modulation gating conditions, and governance sequencing logic.

Appendices included with this specification provide supplementary definitions, component registries, and configuration context supporting interpretation of the figures and detailed descriptions. These materials consolidate reference information and promote internal consistency across the disclosure without requiring direct cross-reference for understanding the supervisory logic described herein.

Depiction Rules for Pathways and Internal Subsystems In the drawings, functional pathways and internal subsystems are illustrated using conventions selected for representational clarity and do not define structural hierarchy, execution order, or physical arrangement. Certain components may include internal analytical, supervisory, or processing elements that are depicted either within the component boundary or as separate blocks to improve legibility and reduce visual congestion. Similarly, pathway signals may be shown entering or exiting a component boundary even when a subordinate internal element performs the associated evaluation or action. These depiction choices do not alter or limit the functional relationships among components. The diagrams convey supervisory flow, trajectory modeling relationships, and modulation authority independent of physical layout or implementation topology. Omission of a particular pathway, enclosure, or internal element in a specific figure does not imply absence of such structure in alternative embodiments, and equivalent representations or configurations that preserve the disclosed supervisory behavior are considered within scope.

### Control and Authority Representation

In the figures described herein, directional arrows emphasize supervisory influence, evaluation authority, and modulation origination rather than solely representing data transport. Arrow origin is associated with the component from which trajectory evaluation, constraint enforcement, or modulation conditions are determined, while arrow destination is associated with the component that executes, conditions, or responds to such supervisory logic. Although signals may be bidirectional or distributed in implementation, the figures emphasize authoritative directionality for representational clarity and to distinguish supervisory governance from underlying state-generation processes. These representations do not limit the directionality, distribution, or implementation of control logic in alternative embodiments.

### Detailed Description of the Drawings

### Supervisory Modulation Framework (FIG. 1)

FIG. 1 illustrates the Supervisory Modulation Framework (3000), which provides a high-level architectural representation of a supervisory trajectory-governance system configured to operate across modulated state-based environments. The Supervisory Modulation Framework (3000) encompasses the Internal Trajectory Governance Core (3002) and representative external entities, including the Agent Entity (2530), Sense Ecosystem Systems (2500), and External Systems and External Entities (2510). In certain embodiments, the Agent Entity (2530) may comprise one or more human agents, artificial agents, rule-based systems, autonomous systems, or combinations thereof.

The Internal Trajectory Governance Core (3002) contains a set of supervisory components configured to receive experiential signal inputs, model evolving experiential state, evaluate directional trajectory characteristics relative to defined anchor constraints, and apply bounded modulation to condition trajectory evolution at one or more points along trajectory progression. The components depicted within the Internal Trajectory Governance Core (3002) represent functional designations and may be implemented in centralized, distributed, modular, or integrated configurations without altering the supervisory intent of the architecture.

Experiential signals may originate from the Agent Entity (2530), Sense Ecosystem Systems (2500), External Systems and External Entities (2510), or any combination thereof. Such signals are received by the Experiential Signal Intake Normalization Layer (3004). The Experiential Signal Intake Normalization Layer (3004) is configured to receive, condition, normalize, scale, or otherwise prepare experiential signal inputs for structured modeling. In various embodiments, the Experiential Signal Intake Normalization Layer (3004) may apply filtering, signal harmonization, threshold conditioning, feature mapping, or equivalent preprocessing operations to produce structured signal representations suitable for trajectory analysis. The Supervisory Modulation Framework (3000) operates on interpreted signal states and is not dependent on the originating interface, signal acquisition method, or transmission modality. Experiential signals are processed as state conditions for trajectory evaluation and modulation regardless of how such signals are obtained or conveyed, without requiring modification to the core trajectory governance mechanisms. Experiential signals received by the Experiential Signal Intake Normalization Layer (3004) may include emotional, behavioral, contextual, environmental, or interaction-derived signals.

Outputs of the Experiential Signal Intake Normalization Layer (3004) are provided to the Experiential State Modeling Layer (3006). The Experiential State Modeling Layer (3006) is configured to represent experiential state as a structured, multi-dimensional state vector, state map, or equivalent representation capable of directional evolution across time, progression cycles, or interaction intervals. The Experiential State Modeling Layer (3006) may incorporate contextual parameters, environmental variables, behavioral markers, structural progression indicators, narrative progression markers, or other state dimensions depending on the modulated environment in which the system operates.

The Experiential State Modeling Layer (3006) provides state representations to the Trajectory Vector Engine (3008). The Trajectory Vector Engine (3008) is configured to determine directional evolution characteristics of the modeled experiential state, including trajectory direction, gradient magnitude, acceleration, volatility, or other derived trajectory attributes. The Trajectory Vector Engine (3008) may evaluate temporal progression, directional slope, rate of change, or equivalent metrics describing how experiential state evolves relative to prior state conditions.

The Anchor Designation Engine (3010) defines one or more anchor constraints against which state evolution is evaluated. These constraints may include stability envelopes, reference conditions, or target trajectory parameters. Anchor constraints defined by the Anchor Designation Engine (3010) may represent stability envelopes, directional boundaries, escalation thresholds, coherence conditions, or other supervisory reference constructs. The Anchor Designation Engine (3010) provides constraint reference information to the Drift Detection and Volatility Analysis Engine (3012).

The Drift Detection and Volatility Analysis Engine (3012) receives trajectory characteristics from the Trajectory Vector Engine (3008) and anchor reference information from the Anchor Designation Engine (3010). The Drift Detection and Volatility Analysis Engine (3012) evaluates deviation magnitude, volatility gradients, escalation slope, stability envelope proximity, or equivalent divergence metrics describing the relationship between the evolving experiential state and defined anchor constraints. The Drift Detection and Volatility Analysis Engine (3012) determines whether trajectory conditions satisfy supervisory criteria for modulation at one or more points along trajectory progression.

Based on evaluated trajectory conditions, including deviation magnitude, escalation acceleration, or volatility characteristics, the Drift Detection and Volatility Analysis Engine (3012) provides evaluation outputs to the Constraint Enforcement Layer (3014). The Constraint Enforcement Layer (3014) applies bounded supervisory logic to determine modulation scope, intensity, eligibility, or gating conditions. The Constraint Enforcement Layer (3014) may define modulation thresholds, rate-limiting parameters, escalation damping criteria, counterbalancing requirements, or equivalent bounded regulatory constructs.

In certain embodiments, the Constraint Enforcement Layer (3014) provides control directives to the Feedforward Pre-Escalation Controller (3016). The Feedforward Pre-Escalation Controller (3016) is configured to apply modulation based on projected trajectory conditions, including conditions prior to destabilizing divergence, stability envelope boundary interaction, cascade conditions, or projected instability. The Feedforward Pre-Escalation Controller (3016) may operate based on acceleration indicators, directional projections, projected stability envelope boundary interaction conditions, or other forward trajectory characteristics derived from the Drift Detection and Volatility Analysis Engine (3012) or the Trajectory Vector Engine (3008).

The Constraint Enforcement Layer (3014) and the Feedforward Pre-Escalation Controller (3016) provide modulation directives to the Bidirectional Modulation Mechanism (3018). The Bidirectional Modulation Mechanism (3018) is configured to apply bounded modulation to experiential state evolution. In various embodiments, the Bidirectional Modulation Mechanism (3018) may implement gating, rate limiting, eligibility conditioning, counterbalancing injection, suppression, amplification, escalation damping, scheduled re-weighting, or equivalent bounded modulation strategies. Modulation applied by the Bidirectional Modulation Mechanism (3018) conditions trajectory evolution without replacing underlying state-generation processes.

Outputs of the Bidirectional Modulation Mechanism (3018) may be applied to Sense Ecosystem Systems (2500) and External Systems and External Entities (2510). Through such outputs, the Supervisory Modulation Framework (3000) conditions evolving experiential state across interconnected systems while preserving the autonomy of underlying content-generation, interaction, or simulation mechanisms. In the absence of such supervisory trajectory governance, evolving experiential state conditions may exhibit drift, escalation amplification, or instability under certain conditions. Although signals may flow bidirectionally in implementation, FIG. 1 emphasizes supervisory origination of modulation authority within the Internal Trajectory Governance Core (3002).

FIG. 1 presents a high-level supervisory arrangement in which the depicted components cooperate to provide trajectory governance within a modulated state-based environment. In alternative embodiments, individual components may be merged, distributed, consolidated, functionally decomposed, or partially deployed without departing from the disclosed trajectory-governance framework. Omission, reconfiguration, or redistribution of particular analytical or modulation elements in specific deployments does not preclude the presence of equivalent supervisory logic configured to evaluate deviation relative to anchor constraints and apply bounded trajectory modulation mechanisms consistent with the intent described herein.

### Experiential State Modeling Architecture (FIG. 2)

FIG. 2 illustrates the Experiential State Modeling Architecture (3050), which defines the internal functional structure of the Experiential State Modeling Layer (3006). The Experiential State Modeling Layer (3006) is configured to construct structured representations of experiential state, apply domain normalization, and integrate temporal progression. The Experiential State Modeling Layer (3006) further derives directional characteristics and provides trajectory-compatible information to downstream supervisory components. The modeling structure operates independently of governance enforcement, providing a computational foundation for trajectory evaluation without directly imposing modulation constraints. In the absence of such structured modeling, derived trajectory characteristics may exhibit inconsistency, instability, or reduced interpretability under certain conditions.

In some embodiments, experiential signal inputs consumed by the Experiential State Modeling Layer (3006) may originate from a structured signal generation architecture. FIG. 9, the Experiential Signal Intake and Normalization Architecture (3400), depicts one embodiment of the Experiential Signal Intake Normalization Layer (3004) capable of producing normalized experiential signal packets suitable for downstream state modeling.

The Variable Domain Registry (3058) serves as a definitional system that establishes the allowable variable domains, dimensional categories, and structural constraints used to construct state representations. These domains may include emotional, contextual, environmental, or system-derived variable domains. The Variable Domain Registry (3058) provides reference definitions to the Multi-Dimensional State Vector Constructor (3052), which generates structured state vectors consistent with the registered domains.

The Multi-Dimensional State Vector Constructor (3052) produces state vectors representing a quantified snapshot of the current experiential state across multiple dimensions. Each dimension may correspond to a defined emotional intensity, cognitive parameter, environmental factor, or derived composite metric. In some embodiments, the State Normalization Interface (3068) conditions the constructed vectors to support scale alignment, dimensional weighting, threshold bounding, or inter-domain harmonization prior to mapping operations.

The State Map Representation Engine (3054) represents normalized state vectors within a structured state-space. This representation may include coordinate placement within a multi-dimensional state field, projection onto defined state clusters, or alignment relative to designated anchor regions. The State Map Representation Engine (3054) provides a geometric or relational framework that supports temporal and directional analysis.

The Temporal Progression Axis (3056) integrates temporal sequencing into state evaluation. The Temporal Progression Axis (3056) may incorporate discrete sampling intervals, continuous-time modeling, or event-driven state updates. The State Evolution Tracker (3060) receives mapped state data from the State Map Representation Engine (3054) and integrates temporal progression information from the Temporal Progression Axis (3056) to track changes in state over time.

The State Evolution Tracker (3060) evaluates sequential state transitions and may compute displacement, acceleration, persistence, or oscillatory characteristics within the defined state-space. In the illustrated embodiment, the State Evolution Tracker (3060) provides outputs to both the Directional Gradient Analyzer (3062) and the State Snapshot Buffer (3064). The State Snapshot Buffer (3064) may store discrete state records, historical progression data, or event-triggered captures for reference, logging, or downstream analytical use.

The Directional Gradient Analyzer (3062) derives directional characteristics from tracked state evolution, including trajectory slope, vector magnitude, directional bias relative to anchor regions, or deviation tendencies. The output of the Directional Gradient Analyzer (3062) is provided to the Projection Interface to Trajectory Vector Engine (3066), which formats derived trajectory information for use by the Trajectory Vector Engine (3008) within the Internal Trajectory Governance Core (3002).

Collectively, the components within the Experiential State Modeling Layer (3006) define a structured modeling architecture that transforms domain-defined experiential variables into temporally conditioned, directionally characterized trajectory representations. While the illustrated embodiment depicts one arrangement of components, equivalent implementations may merge, subdivide, reorder, or distribute these components, and may operate iteratively, concurrently, or non-linearly, provided that the resulting system constructs multi-dimensional experiential state representations, integrates temporal progression, evaluates directional evolution, and produces trajectory-compatible outputs for downstream governance mechanisms.

### Trajectory Vector Engine Logic Architecture (FIG. 3)

FIG. 3 illustrates the internal functional structure of the Trajectory Vector Engine Logic Architecture (3100), which represents the analytical computation framework through which the Trajectory Vector Engine (3008) derives structured trajectory features from modeled experiential state information. Within the Trajectory Vector Engine Logic Architecture (3100), the Trajectory Vector Engine (3008) operates as an analytical computation layer configured to derive directional, magnitude-based, and projection-oriented trajectory representations for downstream supervisory analysis. In the absence of such trajectory derivation, evaluation of evolving experiential state may exhibit reduced interpretability, incomplete directional characterization, or instability under certain conditions.

In the illustrated embodiment, modeled state information is received through the Projection Interface to Trajectory Vector Engine (3066), which provides structured state outputs from the Experiential State Modeling Layer (3006). These inputs are received by the Trajectory Input Aggregator (3102), which consolidates incoming state vectors, temporal parameters, and associated modeling attributes into a unified analytical input structure for trajectory computation.

The Directional Vector Generator (3104) computes directional characteristics of state progression based on the aggregated inputs. Directional computation may include determination of vector orientation within a multidimensional state space, derivation of rate-of-change components, or identification of dominant progression axes. The Gradient Magnitude Calculator (3106) derives magnitude-related metrics corresponding to the intensity or velocity of directional change within the modeled state domain.

The Escalation Slope Estimator (3108) evaluates the rate at which state progression may be accelerating or decelerating over time, generating slope-based descriptors that quantify escalation characteristics without applying classification or constraint logic. The Volatility Metric Constructor (3110) derives quantitative measures reflecting oscillation frequency, variance patterns, deviation amplitude, or similar instability indicators within the computed trajectory. In the illustrated configuration, these metrics represent computed descriptors only and do not perform interpretive or enforcement functions.

The Projection Window Manager (3112) defines temporal or analytical windows over which trajectory projections are generated. The Projection Window Manager (3112) may define windows including fixed-duration intervals, sliding temporal frames, adaptive projection horizons, or other bounded analytical scopes. The Trajectory Projection Generator (3114) produces trajectory projections based on computed directional, magnitude, slope, and volatility descriptors within the defined projection window.

Computed trajectory features are provided through the Trajectory Feature Output Interface (3116), which structures the derived analytical outputs for downstream consumption. In the illustrated embodiment, these outputs are encapsulated within a Trajectory Feature Packet (3118), which may contain vector components, magnitude values, slope descriptors, volatility metrics, projection parameters, or related computed attributes. The Trajectory Feature Packet (3118) is provided to the Drift Detection and Volatility Analysis Engine (3012) for subsequent interpretive evaluation and supervisory processing.

The Trajectory Vector Engine (3008) performs computational derivation of trajectory-related features without applying supervisory constraint enforcement, classification of stability states, or modulation decisions. Interpretive analysis, threshold evaluation, and enforcement logic are performed by downstream components, thereby maintaining architectural separation between trajectory computation and supervisory governance functions.

Although the illustrated embodiment depicts a particular computational arrangement, one or more computational elements within the Trajectory Vector Engine (3008) may be merged, distributed, parallelized, reordered, or partially implemented, and may operate iteratively or concurrently, without departing from the disclosed trajectory-feature derivation framework, provided that directional and projection-related descriptors are derived for downstream supervisory analysis.

### Anchor Designation and Constraint Structure (FIG. 4)

FIG. 4 illustrates the internal functional structure of the Anchor Designation Engine (3010), shown within the Anchor Designation and Constraint Structure (3150). The Anchor Designation Engine (3010) is configured to establish reference anchors, construct stability envelopes relative to those anchors, and provide structured deviation evaluation interfaces to downstream supervisory analysis components, including the Drift Detection and Volatility Analysis Engine (3012). In the absence of such anchor-relative constraint structuring, evaluation of evolving experiential state may exhibit reduced stability interpretation, inconsistent deviation assessment, or diminished supervisory precision under certain conditions.

In the illustrated embodiment, anchor sources originate from two principal components: the Static Anchor Registry (3152) and the Dynamic Anchor Generator (3154). The Static Anchor Registry (3152) stores predefined reference anchors that may include baseline experiential states, normative ranges, policy-defined thresholds, or externally defined stability targets. The Dynamic Anchor Generator (3154) produces anchors derived from evolving experiential context, session history, trajectory trends, cohort-relative baselines, or other contextual inputs. Static and dynamic anchors may operate independently or in coordination depending on governance configuration.

Anchor parameter regulation and supervisory authority are governed by the Anchor Governance Controller (3164), which applies policy constraints, precedence rules, weighting logic, and override conditions to regulate anchor selection, modification, activation, or deactivation. The Anchor Governance Controller (3164) may determine whether static, dynamic, or composite anchor configurations are used for a given evaluation context and may enforce bounded parameter adjustments consistent with system-level supervisory policies.

Anchor definitions and associated parameters are stored and referenced through the Anchor Parameter Store (3160), which maintains anchor-specific attributes including threshold bounds, tolerance ranges, permissible deviation gradients, temporal validity parameters, and related constraint metadata. The Anchor Parameter Store (3160) provides structured anchor data to downstream constraint processing components. In certain implementations, the Dynamic Anchor Generator (3154) may reference anchor parameter definitions maintained within the Anchor Parameter Store (3160) when constructing dynamically generated anchors, wherein such reference access provides parameter inputs without conferring supervisory control over anchor generation behavior. The Anchor Parameter Store (3160) may also provide anchor-related parameter inputs to the Stability Envelope Constructor (3156) for envelope formation relative to defined bounds or tolerances.

The Constraint Reference Mapper (3158) receives anchor definitions and associated parameters from the Static Anchor Registry (3152) and the Dynamic Anchor Generator (3154) and transforms them into structured constraint references suitable for envelope construction and deviation comparison. The Constraint Reference Mapper (3158) may normalize anchor parameters, resolve precedence among multiple anchors, and generate reference constructs that can be evaluated against experiential state inputs without embedding volatility classification logic within the anchor subsystem. In the illustrated embodiment, the Constraint Reference Mapper (3158) provides structured constraint references to both the Stability Envelope Constructor (3156) and the Deviation Evaluation Interface (3162).

The Stability Envelope Constructor (3156) uses constraint references and associated anchor parameters to generate bounded stability envelopes that define acceptable deviation ranges relative to designated anchors. These envelopes may be static or dynamically recomputed based on anchor updates, temporal progression, or governance adjustments. The Stability Envelope Constructor (3156) produces structured envelope definitions that establish the permissible state space within which experiential evolution is considered stable or compliant and provides those envelope definitions to the Deviation Evaluation Interface (3162).

The Deviation Evaluation Interface (3162) provides anchor-relative constraint definitions and stability envelope parameters to the Drift Detection and Volatility Analysis Engine (3012). The Deviation Evaluation Interface (3162) does not perform drift or volatility classification itself but provides the structured anchor references and envelope constructs required for downstream deviation assessment. This separation preserves architectural modularity by isolating anchor designation and constraint construction from volatility evaluation and escalation logic.

Arrows depicted in FIG. 4 illustrate the structural relationships through which anchor designation, governance control, constraint mapping, envelope construction, and deviation-interface generation are coordinated within the Anchor Designation Engine (3010), as well as the provision of deviation-related references to the Drift Detection and Volatility Analysis Engine (3012). Although the illustrated embodiment shows discrete components, equivalent functionality may be implemented through consolidated, distributed, or partially deployed configurations without departing from the anchor-relative governance framework described herein.

### Drift Detection and Volatility Analysis Flow (FIG. 5)

FIG. 5 illustrates the Drift Detection and Volatility Analysis Flow (3200), which defines the internal architecture of the Drift Detection and Volatility Analysis Engine (3012). The Drift Detection and Volatility Analysis Engine (3012) is configured to evaluate deviation between projected experiential trajectory and anchor parameters, assess proximity to defined stability envelopes, determine escalation conditions, and produce structured volatility classification signals for downstream supervisory enforcement processing. The Drift Detection and Volatility Analysis Engine (3012) performs analytical evaluation only and does not directly impose modulation or constraint enforcement actions.

The Trajectory Feature Intake Interface (3202) receives structured trajectory data from the Trajectory Feature Packet (3118). The trajectory data may include projected directional vectors, gradient magnitude metrics, volatility characteristics, or time-conditioned projection parameters derived from the Trajectory Vector Engine (3008). The Anchor Parameter Intake Interface (3204) receives reference parameters from the Anchor Parameter Store (3160) and deviation evaluation inputs from the Deviation Evaluation Interface (3162). These inputs collectively provide the reference anchor definitions, stability envelope boundaries, and constraint mappings against which deviation is evaluated.

The Deviation Magnitude Calculator (3206) computes quantitative deviation metrics by comparing projected, observed, or evolving trajectory characteristics to the received anchor parameters and stability definitions. Deviation magnitude may be expressed as vector displacement, scalar offset, multi-dimensional distance, directional divergence, or composite deviation indices depending on the embodiment. The computed deviation values are provided to the Envelope Proximity Analyzer (3208).

The Envelope Proximity Analyzer (3208) evaluates the relationship between computed deviation magnitude and predefined stability envelope boundaries. The Envelope Proximity Analyzer (3208) may determine whether projected trajectory remains within acceptable tolerance regions, approaches boundary thresholds, or exceeds defined envelope constraints. Proximity assessment may incorporate static thresholds, dynamically adjusted envelope parameters, or context-sensitive tolerance adjustments supplied by the Anchor Designation Engine (3010).

The Escalation Threshold Evaluator (3210) determines whether deviation conditions satisfy predefined escalation criteria. Escalation thresholds may correspond to magnitude exceedance, rate-of-change acceleration, persistence duration, volatility amplification, or compound deviation conditions. The Escalation Threshold Evaluator (3210) outputs escalation determination signals to the Drift Severity Classifier (3212).

The Drift Severity Classifier (3212) assigns a structured severity classification to the evaluated deviation condition. Severity levels may represent graduated tiers such as nominal variance, early-stage drift, pre-escalation instability, or critical divergence. The Drift Severity Classifier (3212) produces structured volatility classification data for downstream handling.

In certain embodiments, the deviation, proximity, escalation, and classification analysis supports one or more Trajectory Intervention Policies used by downstream enforcement mechanisms. Such policies may include anticipatory intervention conditions triggered by projected approach toward a stability envelope boundary, threshold-based intervention conditions triggered at or near a designated envelope boundary condition, corrective intervention conditions triggered following deviation beyond a stability envelope boundary or sustained divergence beyond envelope limits, or adaptive intervention policies in which modulation sensitivity is dynamically adjusted based on trajectory slope, volatility gradients, escalation acceleration, persistence duration, or other trajectory-governance indicators. The Drift Detection and Volatility Analysis Engine (3012) may produce classification signals indicating such conditions without directly executing modulation or enforcement actions, with anticipatory intervention representing a preferred or primary supervisory mode in certain embodiments.

The Volatility Classification Output Interface (3214) formats the classified deviation data into a structured Drift Signal Packet (3216). The Drift Signal Packet (3216) encapsulates deviation magnitude indicators, envelope proximity state, escalation status, and severity classification attributes. The Drift Signal Packet (3216) is provided via the Enforcement Handoff Interface (3218) to the Constraint Enforcement Layer (3014) for independent enforcement processing within the Internal Trajectory Governance Core (3002).

While the illustrated embodiment depicts a particular analytical arrangement, equivalent implementations may merge, subdivide, reorder, parallelize, or distribute the described analytical components, and may operate prior to, during, or following deviation relative to defined anchor constraints or stability envelope conditions, provided that the system performs structured deviation measurement relative to anchor parameters, evaluates envelope proximity, determines escalation conditions, and produces classified volatility signals for downstream enforcement processing without directly executing constraint enforcement within the Drift Detection and Volatility Analysis Engine (3012).

### Constraint Enforcement and Modulation Pathways (FIG. 6)

FIG. 6 illustrates the Constraint Enforcement and Modulation Pathways (3250), which defines the internal architecture of the Constraint Enforcement Layer (3014). The Constraint Enforcement Layer (3014) is configured to evaluate structured volatility classification signals to determine governed modulation strategies and determine whether, when, and how modulation actions are permitted or applied within the supervisory control hierarchy based on projected, observed, or evolving trajectory conditions prior to, during, or following deviation relative to defined anchor constraints or stability envelope conditions. The Constraint Enforcement Layer (3014) performs enforcement determination and modulation selection without directly executing modulation effects, which are applied by downstream execution mechanisms. In the absence of such enforcement determination, system behavior may exhibit unbounded escalation, ineffective modulation application, or inconsistent response to deviation conditions under certain scenarios.

The Enforcement Input Interface (3252) receives structured enforcement signals derived from upstream drift evaluation processes. These signals may include severity classification, escalation status, deviation magnitude indicators, and contextual policy parameters. The received inputs are processed by the Policy and Eligibility Gate (3254), which determines whether modulation actions are permitted, restricted, deferred, or conditionally enabled based on predefined policies, contextual constraints, system state, or composite evaluation criteria. In certain conditions, the Policy and Eligibility Gate (3254) may determine that modulation actions are not permitted, resulting in operation of the supervisory system in a monitoring or advisory capacity in which trajectory conditions are evaluated and recommendations may be generated without application of modulation.

The Modulation Strategy Selector (3256) evaluates eligible enforcement conditions and determines one or more appropriate modulation strategies. In the illustrated embodiment, the selector may activate any of the Rate Limiting Modulator (3258), Re-Weighting Modulator (3260), Signal Injection Modulator (3262), Suppression Modulator (3264), or Amplification Modulator (3266). These modulation mechanisms represent distinct modulation categories and may operate independently or in combination. In certain embodiments, the selector may further activate additional modulation mechanisms defined according to the same supervisory modulation principles described herein, including mechanisms that adjust trajectory progression, signal influence, parameter weighting, or state transition behavior through alternative or composite modulation techniques.

The Rate Limiting Modulator (3258) may constrain modulation intensity, frequency, or rate of change. The Re-Weighting Modulator (3260) may adjust relative weighting among competing signals, priorities, or parameters. The Signal Injection Modulator (3262) may introduce additional corrective or stabilizing inputs. The Suppression Modulator (3264) may attenuate or inhibit selected signals. The Amplification Modulator (3266) may increase the magnitude or emphasis of selected parameters.

Modulation directives generated by the Constraint Enforcement Layer (3014) may vary in magnitude, frequency, cadence, or application rate based on evaluated trajectory conditions, including deviation magnitude, escalation indicators, or proximity to defined stability envelope boundaries.

Outputs from the activated modulation mechanisms are provided to the Modulation Output Router (3268), which consolidates, sequences, or prioritizes modulation actions as required. The Modulation Output Router (3268) generates a structured Modulation Action Packet (3270) encapsulating the selected modulation directives. The Modulation Action Packet (3270) is provided via the Execution Handoff Interface (3272) to the Feedforward Pre-Escalation Controller (3016) and/or the Bidirectional Modulation Mechanism (3018) for execution within the broader supervisory modulation framework.

While the illustrated embodiment depicts a branching taxonomy of modulation strategies selected after eligibility gating, modulation mechanisms may be applied individually or in combination, and execution order may be configurable. Eligibility gating may occur prior to, concurrent with, or subsequent to strategy selection, and hierarchical gating embodiments are contemplated. Equivalent implementations may merge, subdivide, reorder, or distribute enforcement and modulation components provided that the system translates enforcement determinations into structured modulation directives without collapsing enforcement evaluation and execution into a single undifferentiated process.

### Feedforward Pre-Escalation Control Architecture (FIG. 7)

FIG. 7 illustrates the Feedforward Pre-Escalation Control Architecture (3300), which defines the internal architecture of the Feedforward Pre-Escalation Controller (3016). The Feedforward Pre-Escalation Controller (3016) is configured to evaluate projected, observed, or evolving trajectory behavior and drift indicators prior to, during, or following deviation relative to defined anchor constraints or stability envelope conditions to determine projected instability conditions before escalation thresholds are reached. The Feedforward Pre-Escalation Controller (3016) generates structured pre-escalation modulation actions that may be applied to stabilize trajectory progression or inform downstream enforcement processing without directly executing modulation effects. In the absence of such forward trajectory evaluation, system behavior may exhibit delayed response to instability, reactive-only correction patterns, or increased likelihood of escalation under certain conditions.

In preferred embodiments, the Feedforward Pre-Escalation Controller (3016) operates as a primary supervisory control mechanism configured to maintain trajectory stability prior to boundary exceedance conditions.

The Projection Intake Interface (3302) receives projection and trajectory-related signals derived from upstream analytical components including the Trajectory Vector Engine (3008) and, in some embodiments, contextual indicators generated by the Drift Detection and Volatility Analysis Engine (3012), along with additional supervisory context signals available within the Internal Trajectory Governance Core (3002). These inputs may include projected trajectory vectors, gradient indicators, drift classifications, or other trajectory-related descriptors used for forward trajectory evaluation.

The received inputs are evaluated by the Acceleration Indicator Analyzer (3304), which analyzes changes in trajectory behavior across successive projection intervals. The Acceleration Indicator Analyzer (3304) may evaluate acceleration characteristics including increasing deviation velocity, directional persistence, or rapid changes in trajectory slope. The results of this analysis are represented as a Trajectory Acceleration Metric (3306), which provides a quantified indicator of forward instability risk.

The Trajectory Acceleration Metric (3306) is evaluated by the Pre-Threshold Activation Evaluator (3308), which determines whether anticipatory control actions should be initiated prior to formal escalation conditions. Activation criteria may consider acceleration magnitude, directional persistence, projected drift trajectory, contextual policy thresholds, or combinations thereof. When pre-threshold activation conditions are satisfied, the Forward Risk Estimator (3310) is engaged to perform forward risk evaluation.

The Forward Risk Estimator (3310) evaluates projected trajectory outcomes using the available acceleration and trajectory indicators. The Forward Risk Estimator (3310) may determine projected deviation severity, estimated time-to-threshold crossing, or other forward stability indicators that inform appropriate control actions.

Based on the evaluated forward risk conditions, the Proportional Response Generator (3312) determines an appropriate corrective response magnitude and strategy. In some embodiments, the response may be scaled proportionally to projected instability indicators, enabling graduated corrective adjustments rather than abrupt enforcement escalation.

The generated response is encapsulated within a structured Pre-Escalation Adjustment Packet (3314), which defines the corrective modulation directives determined by the Feedforward Pre-Escalation Controller (3016). The Pre-Escalation Adjustment Packet (3314) is transmitted through the Pre-Escalation Output Interface (3316), which communicates the generated adjustment directives to downstream components such as the Bidirectional Modulation Mechanism (3018) and, in some embodiments, the Constraint Enforcement Layer (3014).

While the illustrated embodiment depicts a particular analytical arrangement for forward trajectory analysis and pre-escalation response generation, equivalent implementations may merge, subdivide, reorder, or distribute these components across multiple processing stages, and may operate sequentially, conditionally, or in parallel depending on system configuration, provided that the Feedforward Pre-Escalation Controller (3016) evaluates forward trajectory indicators and generates structured modulation directives prior to escalation threshold conditions.

### Bidirectional Modulation Mechanism Architecture (FIG. 8)

FIG. 8 illustrates the Bidirectional Modulation Mechanism Architecture (3350), which defines the internal architecture through which the Bidirectional Modulation Mechanism (3018) performs modulation operations within the Supervisory Modulation Framework (3000). The Bidirectional Modulation Mechanism (3018) receives modulation directives generated by the Feedforward Pre-Escalation Controller (3016) and originating from the Constraint Enforcement Layer (3014), and executes structured modulation adjustments based on these directives to modulate downstream operational systems.

The Bidirectional Modulation Mechanism (3018) operates based on modulation directives originating from upstream components and does not independently determine modulation conditions, instead executing modulation in response to such directives without performing independent evaluation. In the absence of such modulation execution, system behavior may exhibit unregulated propagation of destabilizing vectors, insufficient reinforcement of stabilizing conditions, or degraded trajectory coherence under certain scenarios.

In the illustrated embodiment, modulation control inputs are received through the Modulation Intake Interface (3352). The Modulation Intake Interface (3352) functions as a receiving interface that receives and aggregates incoming modulation directives and prepares them for classification and execution within the Bidirectional Modulation Mechanism (3018). Incoming signals may include feedforward adjustment instructions, constraint enforcement responses, or composite modulation directives generated by upstream supervisory components.

The Modulation Intake Interface (3352) forwards received modulation signals to the Modulation Vector Classifier (3354). The Modulation Vector Classifier (3354) evaluates the incoming directives and performs vector-state classification to determine whether the modulation operation should be applied as a destabilizing vector damping response, a stabilizing vector elevation response, or a composite modulation directive combining both forms of modulation.

When the Modulation Vector Classifier (3354) classifies an incoming directive as a destabilizing vector damping response, the directive is routed to the Destabilizing Vector Damping Engine (3356). The Destabilizing Vector Damping Engine (3356) reduces the intensity or propagation of destabilizing system vectors that may otherwise amplify undesirable trajectory deviations or instability conditions. The degree of damping applied is regulated by the Damping Intensity Controller (3360), which determines the magnitude, persistence, or rate of the damping adjustment.

When the Modulation Vector Classifier (3354) classifies an incoming directive as a stabilizing vector elevation response, the directive is routed to the Stabilizing Vector Elevation Engine (3358). The Stabilizing Vector Elevation Engine (3358) enhances stabilizing trajectory vectors within the system by elevating supportive trajectory vectors or reinforcing corrective conditions that promote system stability. The Elevation Intensity Controller (3362) determines the magnitude and proportional scaling of the elevation adjustment applied by the elevation engine.

The outputs of the Damping Intensity Controller (3360) and the Elevation Intensity Controller (3362) are provided to the Dual-Vector Balance Controller (3364). The Dual-Vector Balance Controller (3364) coordinates the interaction between damping and elevation adjustments to ensure that simultaneous modulation adjustments remain balanced and do not produce unintended amplification or suppression effects.

Following balancing operations, the resulting modulation state is evaluated by the Modulation Integrity Validator (3366). The Modulation Integrity Validator (3366) verifies that the combined modulation directives remain within defined policy boundaries, safety limits, or operational constraints prior to system distribution.

Validated modulation directives are forwarded to the Structured Modulation Output Builder (3368), which formats the resulting control instructions into a structured Modulation Output Signal (3370). The Modulation Output Signal (3370) represents the finalized execution directive produced by the Bidirectional Modulation Mechanism (3018).

In the illustrated embodiment, the Modulation Output Signal (3370) may be distributed to downstream operational environments, including Sense Ecosystem Systems (2500) and External Systems and External Entities (2510), where the modulation adjustments may condition narrative systems, simulation environments, communication platforms, training systems, or other interactive architectures.

While the illustrated embodiment depicts a dual-path architecture separating destabilizing damping and stabilizing elevation operations, alternative implementations may apply these modulation strategies individually or in combination. Execution order, intensity scaling, or routing behavior may be dynamically configured based on system policies, contextual conditions, or supervisory control directives. Additionally, modulation strategies may be applied sequentially, concurrently, or hierarchically provided that the Bidirectional Modulation Mechanism (3018) preserves the ability to selectively damp destabilizing vectors, elevate stabilizing vectors, and produce structured modulation outputs suitable for downstream system modulation.

### Experiential Signal Intake and Normalization Architecture (FIG. 9)

FIG. 9 illustrates the Experiential Signal Intake and Normalization Architecture (3400), which defines the internal architecture of the Experiential Signal Intake Normalization Layer (3004) as a signal preparation layer configured to process raw experiential inputs to produce structured signal packets suitable for state modeling and trajectory analysis within the system based on experiential inputs corresponding to system conditions. In the absence of such structured signal intake and normalization, system inputs may exhibit inconsistency, loss of contextual fidelity, or reduced compatibility with downstream state modeling and trajectory evaluation processes under certain conditions.

In the illustrated embodiment, experiential inputs may originate from an Agent Entity (2530) or from External Systems and External Entities (2510). These inputs may include user actions, interactions, narrative events, environmental conditions, communication signals, behavioral indicators, physiological or biometric signals, or other contextual signals conveying experiential information relevant to system evaluation.

Incoming signals are received by the Experiential Signal Intake Interface (3402). The Experiential Signal Intake Interface (3402) operates as an intake and routing component that aggregates incoming experiential signals and provides the signals to the Contextual Signal Parser (3404) for contextual interpretation.

Signals received by the Experiential Signal Intake Interface (3402) are forwarded to the Contextual Signal Parser (3404). The Contextual Signal Parser (3404) evaluates the incoming signals to identify contextual characteristics associated with the signal source, environmental conditions, interaction context, or narrative state. The contextual parsing process may identify signal attributes such as source identity, interaction timing, environmental triggers, or contextual relevance indicators.

The contextually interpreted signals are provided to the Narrative Event Extractor (3406). The Narrative Event Extractor (3406) identifies interaction events or narrative-relevant occurrences contained within the contextual signal stream. These events may correspond to user actions, system events, dialogue interactions, environmental triggers, or other experiential occurrences capable of influencing system evaluation.

Extracted events are forwarded to the Experiential Signal Quantizer (3408). The Experiential Signal Quantizer (3408) converts experiential indicators associated with the extracted events into quantifiable signal representations suitable for computational processing. In some embodiments, the Experiential Signal Quantizer (3408) may assign numerical values, categorical labels, intensity measurements, or other quantifiable representations corresponding to experiential characteristics inferred from the signal inputs.

The quantized experiential signals are then provided to the Signal Fusion and Normalization Engine (3410). The Signal Fusion and Normalization Engine (3410) merges signals originating from multiple sources and applies normalization processes to produce a consistent signal structure. Normalization may include scale alignment, signal weighting, signal aggregation, dimensional harmonization, or other processes that ensure compatibility across signals generated from heterogeneous input sources.

Normalized signals produced by the Signal Fusion and Normalization Engine (3410) are transmitted to the Experiential Signal Packet Builder (3412). The Experiential Signal Packet Builder (3412) constructs a structured signal packet representing the processed experiential signal information. In some embodiments, the packet may include quantized experiential indicators, contextual metadata, source identifiers, or time-related attributes.

The resulting Normalized Experiential Signal Packet (3414) represents the finalized output of the Experiential Signal Intake Normalization Layer (3004). The Normalized Experiential Signal Packet (3414) is transmitted to the Experiential State Modeling Layer (3006) for construction of structured experiential state representations and support of downstream trajectory modeling and supervisory evaluation within the Internal Trajectory Governance Core (3002).

While the illustrated embodiment depicts a particular signal processing arrangement, equivalent implementations may merge, subdivide, reorder, or distribute these processing operations provided that the system performs intake of experiential signals, contextual interpretation, extraction of narrative-relevant events, quantization of experiential indicators, normalization of heterogeneous signal inputs, and construction of structured experiential signal packets suitable for downstream state modeling operations.

### Degraded Variant Supervisory Architecture (FIG. 10)

FIG. 10 illustrates the internal architecture of the Lightweight Supervisory Core (3452) within the Degraded Variant Supervisory Architecture (3450). The Degraded Variant Supervisory Architecture (3450) represents a simplified supervisory embodiment configured to perform experiential drift detection and modulation response generation using a reduced set of supervisory components while preserving core supervisory trajectory-governance functionality within a reduced architectural form. This embodiment illustrates that supervisory modulation functionality may be implemented using a lightweight architecture capable of performing limited experiential evaluation while still generating modulation responses capable of influencing downstream system behavior based on projected, observed, or evolving experiential conditions prior to, during, or following deviation relative to a reference condition. In the absence of such simplified supervisory evaluation, system behavior may exhibit unbounded deviation, delayed detection of instability, or absence of corrective modulation under certain conditions.

In the illustrated embodiment, experiential signals may originate from an Agent Entity (2530) or from External Systems and External Entities (2510). These signals may include user actions, interaction events, environmental signals, communication activity, or other contextual inputs capable of conveying experiential information relevant to supervisory evaluation.

Incoming experiential signals are received by the Minimal Experiential Signal Intake (3454). The Minimal Experiential Signal Intake (3454) operates as a simplified intake component that aggregates incoming experiential signals and provides them for evaluation within the lightweight supervisory architecture.

Signals received by the Minimal Experiential Signal Intake (3454) are forwarded to the Single-Axis Drift Evaluator (3456). The Single-Axis Drift Evaluator (3456) performs a simplified evaluation of experiential state by assessing deviation along a defined signal dimension or supervisory indicator. In contrast to the multi-dimensional trajectory evaluation performed within the Internal Trajectory Governance Core (3002), the Single-Axis Drift Evaluator (3456) evaluates experiential drift using a reduced analytical model.

Drift evaluation results produced by the Single-Axis Drift Evaluator (3456) are evaluated relative to a reference condition. The Lightweight Anchor Reference (3458) represents a simplified baseline state used to determine acceptable experiential states within the degraded supervisory architecture.

The evaluated signal state and reference condition are processed by the Simplified State Comparator (3460). The Simplified State Comparator (3460) determines whether the detected experiential state deviates sufficiently from the anchor reference to justify the initiation of a modulation response.

When a deviation condition is detected, the Simplified State Comparator (3460) invokes the Minimal Modulation Output Generator (3462). The Minimal Modulation Output Generator (3462) produces a Lightweight Modulation Signal (3464) representing a simplified supervisory response intended to influence downstream system behavior.

The Lightweight Modulation Signal (3464) represents the output of the Lightweight Supervisory Core (3452). In the illustrated embodiment, the modulation signal may be transmitted to External Systems and External Entities (2510) and/or Sense Ecosystem Systems (2500), where the signal may modulate system behavior, user interaction conditions, or other experiential outputs.

While the illustrated embodiment depicts a simplified supervisory architecture employing single-axis drift evaluation and reduced modulation generation, alternative implementations may extend or modify this structure while preserving the core supervisory function of detecting experiential deviation relative to a reference condition. Equivalent implementations may incorporate additional evaluation parameters, alternative reference models, or expanded modulation behaviors provided that the architecture maintains a reduced supervisory structure capable of performing experiential deviation detection relative to a reference condition and producing modulation responses that influence downstream system behavior, thereby preserving core supervisory functionality within a reduced architectural form.

### Domain-Agnostic Deployment Architecture (FIG. 11)

FIG. 11 illustrates the Domain-Agnostic Deployment Architecture (3500), which depicts representative operational environments in which the Supervisory Modulation Framework (3000) may be deployed to provide trajectory-governance and modulation control across multiple classes of interactive systems based on supervisory modulation outputs generated by the Supervisory Modulation Framework (3000). The Domain-Agnostic Deployment Architecture (3500) further illustrates distribution of supervisory modulation outputs through the Cross-Domain Modulation Channel (3512) to multiple independent deployment environments. In the absence of such cross-domain supervisory distribution, system behavior across independent domains may exhibit inconsistent modulation application, uncoordinated trajectory governance, or domain-specific instability under certain conditions.

In the illustrated embodiment, supervisory modulation directives originating from the Supervisory Modulation Framework (3000) are transmitted through the Cross-Domain Modulation Channel (3512). The Cross-Domain Modulation Channel (3512) represents a logical communication pathway through which structured modulation signals may be propagated from the supervisory architecture to external operational domains. The channel may include messaging interfaces, signal routing pathways, integration APIs, middleware transport layers, or equivalent communication mechanisms capable of delivering supervisory outputs to target systems.

The Cross-Domain Modulation Channel (3512) distributes supervisory modulation signals to representative operational environments including, without limitation, the Narrative Systems Domain (3502), Simulation Environments Domain (3504), Enterprise Communication Domain (3506), Training Systems Domain (3508), and Interactive Platforms Domain (3510). Each domain represents a class of systems in which experiential state evolution, interaction dynamics, communication flows, or simulation conditions may be influenced by supervisory modulation outputs generated by the Supervisory Modulation Framework (3000).

The Narrative Systems Domain (3502) may include narrative-driven interactive environments such as storytelling systems, game narratives, dynamic plot frameworks, interactive media experiences, or equivalent narrative progression platforms. Within such systems, supervisory modulation outputs may modulate narrative pacing, experiential escalation patterns, branching conditions, or other narrative-state progression characteristics.

The Simulation Environments Domain (3504) may include virtual simulations, training simulators, behavioral modeling environments, digital twin systems, or other simulation-based platforms in which evolving experiential or behavioral conditions may be modulated. In such deployments, supervisory outputs may modulate simulation parameters, escalation dynamics, scenario progression, or other simulation-state characteristics while preserving autonomy of underlying simulation engines.

The Enterprise Communication Domain (3506) may include enterprise messaging systems, collaborative communication platforms, organizational interaction systems, or other communication infrastructures in which conversational dynamics or information propagation patterns may be influenced by supervisory modulation signals. In such contexts, modulation outputs may modulate communication pacing, interaction escalation characteristics, or message propagation behaviors.

The Training Systems Domain (3508) may include instructional systems, adaptive learning platforms, training simulators, educational environments, or other training-oriented systems in which experiential progression, engagement conditions, or training-state evolution may be influenced through supervisory modulation outputs. Such modulation may influence pacing characteristics, escalation patterns, instructional progression states, or equivalent training parameters.

The Interactive Platforms Domain (3510) may include interactive software systems, social platforms, collaborative digital environments, or other user-interactive infrastructures in which experiential interactions evolve dynamically through user activity. Supervisory modulation outputs may modulate interaction pacing, escalation dynamics, experiential progression, or other interactive-state characteristics.

The domains illustrated in FIG. 11 represent representative categories of operational environments rather than exhaustive enumerations of deployment contexts. In various embodiments, the Supervisory Modulation Framework (3000) may be deployed across additional domains including media systems, behavioral modeling environments, governance platforms, simulation ecosystems, or other modulated state-based systems without departing from the Domain-Agnostic Deployment Architecture (3500) described herein.

FIG. 11 therefore illustrates a deployment architecture in which the Supervisory Modulation Framework (3000) operates as a domain-independent supervisory control system capable of distributing modulation outputs across heterogeneous operational environments through the Cross-Domain Modulation Channel (3512), thereby maintaining consistent supervisory trajectory governance across heterogeneous domains. While the illustrated embodiment depicts a centralized supervisory framework providing outputs to multiple domains, alternative implementations may distribute supervisory logic across modular components, federated architectures, or integrated system environments without departing from the disclosed domain-agnostic supervisory deployment structure.

### Supervisory Interaction Boundary Architecture (FIG. 12)

FIG. 12 illustrates the Supervisory Interaction Boundary Architecture (3550), which defines the system interaction boundary through which the Supervisory Modulation Framework (3000) exchanges experiential signals and supervisory modulation directives with external operational environments. The architecture depicts an External System Interaction Boundary (3552) that separates external systems capable of generating experiential signals from the internal supervisory processing environment. Through the External System Interaction Boundary (3552), experiential signals originating from external systems may be transmitted to the supervisory framework for evaluation, and supervisory modulation outputs may be returned to external systems capable of receiving and applying those directives. In the absence of such a supervisory interaction boundary, signal exchange between external systems and the supervisory framework may exhibit inconsistency, degraded signal integrity, or reduced effectiveness of supervisory modulation under certain conditions.

In the illustrated embodiment, experiential inputs may originate from External Systems and External Entities (2510). These systems may include narrative platforms, simulation environments, communication systems, training infrastructures, interactive software environments, or other operational systems capable of generating experiential signal information relevant to supervisory trajectory evaluation. Such experiential signals are represented within the architecture as External Experiential Signal Sources (3556).

Experiential signals produced by the External Experiential Signal Sources (3556) are received by the Signal Intake Boundary Interface (3554). The Signal Intake Boundary Interface (3554) operates as a boundary intake mechanism that aggregates incoming experiential signals originating from external operational environments and provides those signals for transmission into the supervisory processing architecture.

Signals received by the Signal Intake Boundary Interface (3554) are transmitted through the Bidirectional Signal Exchange Pathways (3560). The Bidirectional Signal Exchange Pathways (3560) represent communication channels that allow experiential signal information to be conveyed across the External System Interaction Boundary (3552) to the Supervisory Modulation Framework (3000). In various embodiments, the Bidirectional Signal Exchange Pathways (3560) may include messaging channels, event streams, data pipelines, integration APIs, middleware interfaces, or equivalent communication mechanisms capable of transmitting experiential signal information between external systems and the Supervisory Modulation Framework (3000).

The Supervisory Modulation Framework (3000) receives experiential signal information transmitted through the Bidirectional Signal Exchange Pathways (3560) and performs supervisory evaluation operations within the internal trajectory governance architecture. Based on the evaluated experiential state, the Supervisory Modulation Framework (3000) may generate supervisory modulation directives intended to modulate downstream operational systems.

Supervisory modulation directives produced by the Supervisory Modulation Framework (3000) are transmitted through the Supervisory Modulation Influence Channel (3562). The Supervisory Modulation Influence Channel (3562) represents an outbound signal pathway through which supervisory modulation signals are delivered toward external operational environments.

Signals transmitted through the Supervisory Modulation Influence Channel (3562) are forwarded to the Supervisory Modulation Output Boundary (3558). The Supervisory Modulation Output Boundary (3558) operates as an outbound boundary interface through which supervisory modulation directives may be delivered to External Systems and External Entities (2510). Through the Supervisory Modulation Output Boundary (3558), external systems may receive supervisory modulation signals capable of influencing system behavior, interaction dynamics, simulation conditions, communication patterns, or other experiential state characteristics.

In certain embodiments, supervisory modulation directives generated by the Supervisory Modulation Framework (3000) may be initiated according to one or more Trajectory Intervention Policies determined within the internal trajectory governance architecture. Such policies may include anticipatory modulation triggered by projected approach toward stability envelope boundaries, threshold-based modulation applied at designated boundary conditions, corrective modulation applied following boundary breach, or adaptive modulation policies in which intervention sensitivity is dynamically adjusted according to trajectory volatility, escalation slope, persistence duration, or other supervisory evaluation criteria.

While the illustrated embodiment depicts a boundary architecture in which experiential signals enter through the Signal Intake Boundary Interface (3554) and modulation outputs exit through the Supervisory Modulation Output Boundary (3558), equivalent implementations may merge, subdivide, or distribute these boundary interfaces across alternative integration architectures. In various embodiments, signal intake and modulation output pathways may be implemented through distributed gateways, federated integration layers, middleware brokers, event-driven architectures, or equivalent communication infrastructures, provided that the supervisory architecture maintains the ability to receive experiential signals from external operational environments and transmit supervisory modulation directives capable of influencing those environments.

### ODAN Interoperability Overview (FIG. 13)

FIG. 13 illustrates the ODAN Interoperability Overview (3600), which depicts the coordination relationship between multiple Sense Ecosystem Systems (2500) and the ODAN Coordination Core (2200) based on synchronization of scope-limited metadata derived from participating system operations. The figure includes representative systems such as SenseEcho (2110), SenseStruct (2105), SenseUI (2115), SenseSimile (2170), SenseCare (2185), SenseGuard (2111), SenseSpace (2120), and SenseLife (2190), each interacting with the ODAN Coordination Core (2200) through the ODAN Participation Interface (2250). The ODAN Participation Interface (2250) provides a standardized exchange boundary through which participating systems exchange scope-limited metadata for cross-system coordination while preserving independent system operation. In the absence of such coordination, participating systems may exhibit fragmented contextual awareness, inconsistent cross-system behavior, or reduced interoperability under certain conditions.

Each participating system operates as an autonomous domain-specific platform maintaining its own internal models, decision logic, and governance safeguards. The ODAN Coordination Core (2200) does not directly modify internal system operations or issue execution commands to participating systems. Instead, the ODAN Coordination Core (2200) functions as an interoperability environment configured to harmonize, validate, and route eligible coordination metadata among participating systems in accordance with consent permissions, policy constraints, and system compatibility conditions.

Metadata transmitted through the ODAN Participation Interface (2250) may include structured coordination indicators, contextual reference signals, confidence-qualified synchronization information, or other scope-limited metadata derived from participating system operations. Raw experiential content, internal model states, and protected user profile data remain within their originating systems and are not transmitted through the ODAN Coordination Core (2200). In various embodiments, provenance attributes may be attached to exchanged metadata to enable receiving systems to evaluate origin, reliability, and contextual applicability.

Arrows illustrated in the figure depict bidirectional signal pathways through which participating systems transmit eligible metadata signals to the ODAN Participation Interface (2250) and receive synchronization signals originating from the ODAN Coordination Core (2200). These pathways represent consent-governed synchronization channels that allow participating systems to maintain contextual awareness of relevant cross-system conditions while independently determining how such information is interpreted or utilized within their respective operational frameworks.

Through this architecture, the ODAN Coordination Core (2200) facilitates cross-system interoperability across the NextEdge ecosystem while preserving system autonomy, enforcing policy boundaries, and maintaining traceable provenance for exchanged coordination metadata, thereby enabling coordinated system awareness without centralized control of participating system behavior. This coordination model enables participating systems to benefit from ecosystem-level contextual awareness while retaining independent control over internal decision-making processes and domain-specific functionality.

### SNARE Recovery and Containment Architecture (FIG. 14)

FIG. 14 illustrates the SNARE Recovery and Containment Architecture (3650), which defines the internal recovery coordination infrastructure of the SNARE Assurance Recovery Engine SE (3652). The architecture governs controlled containment, rollback coordination, continuity preservation, validation, reintegration, and transparency reporting in response to detected system anomalies or threat conditions. The SNARE Assurance Recovery Engine SE (3652) operates as a recovery governance layer that enables compromised components to be isolated and restored while preserving operational continuity and maintaining a verifiable recovery record. In the absence of such a recovery governance architecture, system anomalies or compromise conditions may propagate without containment, resulting in cascading instability, loss of state integrity, or non-recoverable system conditions under certain circumstances.

The SNARE Recovery and Containment Architecture (3650) is illustrated within the context of SenseEcho; however, the architecture may be implemented independently within one or more NextEdge systems requiring controlled containment and recovery mechanisms. Each system may maintain its own SNARE Assurance Recovery Engine SE (3652) instance so that rollback handling, containment decisions, and reintegration procedures remain locally governed within the affected system boundary. External coordination frameworks, including ODAN, may reference high-level recovery state indicators for ecosystem awareness, while recovery execution remains system-local by design.

Recovery coordination is performed by the SNARE Recovery Control Coordinator SE (3654). The SNARE Recovery Control Coordinator SE (3654) receives activation signals from the SNARE Threat Signal Receiver SE (3672) and the SNARE Anomaly Detection Engine SE (3658). Upon receiving a trigger, the SNARE Recovery Control Coordinator SE (3654) evaluates recovery prerequisites, determines recovery scope, and orchestrates downstream containment and restoration operations.

Recovery rollback preparation is managed by the SNARE System Snapshot Controller SE (3656). The SNARE System Snapshot Controller SE (3656) maintains versioned recovery snapshots for designated system components, configurations, and operational states. When rollback is authorized by the SNARE Recovery Control Coordinator SE (3654), the SNARE System Snapshot Controller SE (3656) prepares candidate recovery states for validation and potential restoration.

Isolation of compromised system components is enforced by the SNARE Quarantine Manager SE (3660). The SNARE Quarantine Manager SE (3660) detaches suspect modules or processes from active system pathways and prevents compromised behaviors from propagating through the operational environment. The SNARE Quarantine Manager SE (3660) may remain active until validation procedures confirm that reintegration conditions are satisfied.

User or session continuity during recovery operations is supported by the SNARE Continuity Fallback Model SE (3662). The SNARE Continuity Fallback Model SE (3662) provides simplified system behavior, reduced-load interaction states, or neutral operational defaults while recovery operations are in progress, allowing system interactions to remain stable while primary components are quarantined, rolled back, or undergoing validation.

Restoration integrity is evaluated by the SNARE Trusted State Validator SE (3664). The SNARE Trusted State Validator SE (3664) performs integrity checks on candidate recovery states prepared by the SNARE System Snapshot Controller SE (3656). These evaluations may include verification of configuration alignment, dependency integrity, version compatibility, and operational stability prior to reintegration approval.

Controlled restoration of validated components is managed by the SNARE Reintegration Gateway SE (3666). The SNARE Reintegration Gateway SE (3666) reintroduces approved modules into the operational environment in a controlled manner that reduces the risk of inconsistent system states. Reintegration may include restoration of communication pathways, synchronization of system state elements, and reestablishment of session continuity before normal operation resumes.

Recovery event transparency and auditability are provided through the SNARE Recovery Log Generator SE (3668), the SNARE Recovery Transparency Layer SE (3670), and the SNARE Oversight Transparency Sync Channel SE (3674). The SNARE Recovery Log Generator SE (3668) records recovery triggers, containment actions, validation outcomes, reintegration steps, and resolution states. The SNARE Recovery Transparency Layer SE (3670) provides controlled visibility into recovery progress for authorized stakeholders. The SNARE Oversight Transparency Sync Channel SE (3674) exposes finalized recovery records to authorized oversight environments for compliance monitoring and post-event review.

In the illustrated embodiment, activation signals originate from the SNARE Threat Signal Receiver SE (3672) and the SNARE Anomaly Detection Engine SE (3658) and are received by the SNARE Recovery Control Coordinator SE (3654). Containment actions are executed through the SNARE Quarantine Manager SE (3660), while rollback preparation is coordinated through the SNARE System Snapshot Controller SE (3656). Candidate recovery states are evaluated by the SNARE Trusted State Validator SE (3664), and validated components are restored through the SNARE Reintegration Gateway SE (3666). During recovery operations, the SNARE Continuity Fallback Model SE (3662) maintains system continuity, while recovery events are recorded by the SNARE Recovery Log Generator SE (3668) and communicated through the SNARE Recovery Transparency Layer SE (3670) and the SNARE Oversight Transparency Sync Channel SE (3674).

By separating containment, rollback preparation, continuity preservation, validation, reintegration, and transparency functions into distinct architectural components, the SNARE Recovery and Containment Architecture (3650) enables controlled and auditable recovery behavior across recovery phases associated with system anomaly conditions. This architecture supports restoration of trusted operational states while preserving system stability, maintaining recovery governance integrity, and providing transparent oversight of recovery events.

### Experiential Trajectory Stability Envelope Model (FIG. 15)

FIG. 15 illustrates the Experiential Trajectory Stability Envelope Model (3700), which provides a conceptual representation of how experiential trajectory evolution may be evaluated relative to a stability envelope over time and how supervisory modulation may influence such trajectory evolution prior to the generation of a realized experiential outcome. The model visually demonstrates how experiential state progression evolves along a trajectory path and how that trajectory is evaluated relative to defined stability envelope boundaries.

In preferred embodiments, the supervisory trajectory governance system is configured to maintain experiential trajectory progression within the defined Stability Envelope (3712) through anticipatory or pre-boundary modulation, thereby reducing the likelihood of, or preventing, boundary exceedance conditions.

In the illustrated model, experiential state progression is represented along a vertical experiential state axis, while temporal progression is represented along a horizontal time axis. As experiential state variables evolve within an experiential system, the directional evolution of those variables forms an experiential trajectory that progresses across time. The trajectory may represent changes across one or more experiential state dimensions, including contextual conditions, environmental parameters, interaction dynamics, behavioral attributes, or other experiential variables, and may be evaluated across a plurality of concurrent variables within a multi-dimensional experiential state space.

The figure further depicts a Stability Envelope (3712) representing a bounded region within which experiential trajectory evolution is considered coherent, stable, or acceptable relative to governing anchor constraints. The stability envelope is defined by an Upper Stability Envelope Boundary (3702) and a Lower Stability Envelope Boundary (3704), which together delineate the range of experiential trajectory conditions considered to remain within acceptable supervisory stability parameters. Trajectory conditions within this envelope represent experiential evolution aligned with governing anchor constraints, while trajectory conditions extending beyond the envelope boundaries represent divergence from those constraints.

In certain embodiments, the stability envelope may vary over time or across interaction states based on evolving experiential conditions, and the representation shown in FIG. 15 may correspond to a momentary instance of such an envelope during trajectory evolution.

The figure illustrates two comparative trajectory paths representing alternative experiential trajectory conditions. An Unmodulated Trajectory (3708) illustrates a trajectory path that evolves without supervisory modulation influence. In the depicted example, the unmodulated trajectory progresses toward and subsequently diverges beyond the stability envelope boundaries, representing a condition in which experiential trajectory evolution moves outside the acceptable stability region relative to the governing anchor constraints.

A Modulated Trajectory (3706) is also illustrated to demonstrate how supervisory trajectory governance may influence trajectory evolution prior to sustained boundary deviation. In the illustrated example, supervisory modulation is applied to the evolving trajectory prior to sustained divergence beyond the stability envelope. Through such modulation, the trajectory may be redirected, conditioned, or stabilized so that experiential evolution remains within or returns toward the stability envelope over time. Modulation may include bounded conditioning applied to trajectory direction, rate of change, volatility characteristics, or other experiential state variables.

In certain embodiments, initiation of supervisory modulation may be determined based on one or more trajectory conditions associated with proximity of the experiential trajectory to the stability envelope. Such conditions may include distance to one or more stability envelope boundaries, rate of approach toward a boundary, directional alignment relative to the boundary, or other proximity-related characteristics associated with trajectory progression. Under such configurations, modulation may be initiated prior to, at, or following interaction with a stability envelope boundary, including during projected approach conditions based on forward trajectory evaluation.

Supervisory modulation may be applied according to a governing Trajectory Intervention Policy. Under such policies, modulation may occur prior to, at, or following approach to one or more stability envelope boundaries depending on supervisory configuration and evaluated trajectory conditions. In this manner, modulation is not limited to boundary-triggered intervention and may be applied at multiple phases of trajectory evolution.

Supervisory modulation decisions may be based on evaluation of one or more trajectory conditions including projected trajectory direction, envelope proximity states, volatility characteristics, drift conditions, or other supervisory evaluation metrics associated with experiential trajectory evolution. These conditions may be assessed by supervisory trajectory analysis components to determine whether modulation should be applied to maintain progression within acceptable stability parameters.

The model further depicts an Experiential Outcome Boundary (3710), which represents the temporal position at which the experiential system produces a realized experiential outcome following prior trajectory evolution. The experiential outcome may represent a realized system state, event condition, interaction result, simulation state transition, communication output, or other resolved experiential condition generated by the experiential environment.

In certain embodiments, supervisory trajectory governance operates in a feedforward configuration in which trajectory conditions are evaluated and modulation may be applied prior to the Experiential Outcome Boundary (3710). Under such configurations, supervisory evaluation logic assesses trajectory direction, volatility characteristics, drift conditions, or envelope proximity states during trajectory evolution and initiates modulation according to the governing Trajectory Intervention Policy before destabilizing divergence produces an undesirable experiential outcome.

In contrast, certain conventional systems rely primarily on feedback-based adjustment mechanisms in which adaptation occurs only after outputs have been produced or undesired outcomes have been observed. In such configurations, corrective actions are applied after the experiential outcome has occurred, requiring subsequent adjustments to restore acceptable system behavior.

FIG. 15 therefore illustrates how supervisory trajectory governance operates proactively by evaluating experiential trajectory evolution relative to stability envelope boundaries and applying supervisory modulation during trajectory evolution rather than relying exclusively on post-outcome correction. By influencing trajectory evolution before or during progression toward the Experiential Outcome Boundary (3710), the supervisory system stabilizes experiential progression, mitigates drift conditions, and maintains trajectory behavior within acceptable stability envelopes.

While the illustrated model depicts a two-dimensional conceptual representation of experiential trajectory evolution relative to a stability envelope over time, alternative embodiments may evaluate trajectory behavior across multiple experiential state dimensions, multi-axis stability envelopes, or context-variable stability envelope structures. The visual representation shown in FIG. 15 is therefore intended to illustrate the conceptual supervisory relationship between experiential trajectory evolution, stability envelope boundaries, supervisory modulation, and experiential outcomes, rather than to limit the dimensionality or implementation architecture through which trajectory governance may be performed.

### Experiential Trajectory Deviation and Post-Boundary Modulation Model (FIG. 16)

FIG. 16 illustrates the Experiential Trajectory Deviation and Post-Boundary Modulation Model (3750), which provides a conceptual representation of how supervisory trajectory governance may operate in response to experiential trajectory deviation beyond a defined stability envelope in scenarios where boundary exceedance occurs in the absence of supervisory modulation, or in embodiments in which post-boundary correction is permitted within the supervisory control framework. The model demonstrates how experiential trajectory evolution may be evaluated after boundary exceedance and how supervisory modulation may influence trajectory behavior to restore alignment with governing stability constraints prior to a realized experiential outcome.

In the illustrated model, experiential state progression is represented along a vertical experiential state axis, while temporal progression is represented along a horizontal time axis. As experiential variables evolve over time, the resulting trajectory reflects directional progression across one or more experiential state dimensions within a multi-dimensional experiential state space.

The figure depicts a Stability Envelope (3712) representing a bounded region within which experiential trajectory evolution is considered stable relative to governing anchor constraints. The Stability Envelope (3712) is defined by an Upper Stability Envelope Boundary (3702) and a Lower Stability Envelope Boundary (3704), which together establish the permissible range of experiential trajectory behavior. Trajectory conditions within this envelope represent alignment with governing constraints, while trajectory conditions extending beyond the envelope boundaries represent deviation from those constraints.

The figure further illustrates an Unmodulated Trajectory (3708) representing trajectory evolution in the absence of supervisory modulation. In the depicted example, the unmodulated trajectory progresses toward and subsequently deviates beyond the stability envelope boundaries, continuing along a divergent path that remains outside the stability envelope. This trajectory illustrates a condition in which experiential evolution departs from acceptable supervisory constraints and is not corrected prior to the Experiential Outcome Boundary (3710).

A Modulated Trajectory (3706) is also illustrated to demonstrate supervisory response following boundary deviation. In the depicted example, the modulated trajectory progresses beyond the Upper Stability Envelope Boundary (3702), representing a condition in which experiential trajectory has exceeded acceptable stability limits. Following this deviation, supervisory modulation is applied to influence trajectory evolution, resulting in a directional adjustment that guides the trajectory back toward and into the Stability Envelope (3712).

The re-entry of the Modulated Trajectory (3706) into the Stability Envelope (3712) illustrates that supervisory trajectory governance may operate after boundary exceedance to restore trajectory alignment with governing constraints. Modulation applied in this context may include bounded adjustments to trajectory direction, rate of change, volatility characteristics, or other experiential state variables capable of influencing trajectory behavior.

In certain embodiments, initiation of post-boundary modulation may be conditioned on one or more deviation-related factors including magnitude of boundary exceedance, persistence of deviation, trajectory slope following deviation, or projected trajectory continuation outside the stability envelope. Supervisory modulation may be applied immediately following boundary exceedance or after evaluation of sustained deviation conditions depending on system configuration and governing intervention policies.

The model further depicts an Experiential Outcome Boundary (3710), representing the temporal position at which a realized experiential outcome is produced. In the illustrated example, the modulated trajectory converges toward a stabilized region within the Stability Envelope (3712) prior to the Experiential Outcome Boundary (3710), while the unmodulated trajectory remains outside the envelope, resulting in divergent experiential outcomes.

FIG. 16 therefore illustrates that supervisory trajectory governance is not limited to pre-boundary or anticipatory intervention, but may also operate during post-deviation conditions to restore trajectory stability prior to outcome realization. By applying modulation after deviation has occurred, the supervisory system enables recovery from destabilizing trajectory conditions and improves alignment with acceptable experiential parameters.

In certain implementations, such post-boundary modulation behavior represents a secondary or recovery-oriented supervisory mode complementing primary pre-boundary trajectory stabilization mechanisms.

While the illustrated model depicts a two-dimensional conceptual representation of post-boundary trajectory deviation and recovery behavior, alternative embodiments may evaluate trajectory behavior across multiple experiential state dimensions, multi-axis stability envelopes, or context-dependent constraint structures. The visual representation shown in FIG. 16 is therefore intended to illustrate the supervisory capability to detect deviation beyond stability boundaries and apply modulation to restore trajectory alignment, rather than to limit the dimensionality or implementation architecture of the trajectory-governance system.

### Variations and Alternatives

The Supervisory Modulation Framework (3000) operates on interpreted signal states and is not dependent on the originating interface, signal acquisition method, or transmission modality. Accordingly, the supervisory trajectory-governance architecture is compatible with a wide range of input sources capable of producing interpretable state conditions for trajectory evaluation and modulation. The following embodiments illustrate representative variations in which such signals may be derived from different sources without requiring modification to the core trajectory-governance mechanisms.

Although specific embodiments, modules, processes, and signal relationships are described in connection with the figures, the disclosed supervisory trajectory-governance architecture may be implemented in a variety of structural arrangements, deployment configurations, and operational environments. Components illustrated as distinct elements may be merged, consolidated, distributed, virtualized, or partially implemented depending on system requirements, computational constraints, or platform architecture. Likewise, processes described as sequential stages may be executed in different orders, combined into unified operations, separated into additional processing stages, or implemented through functionally equivalent mechanisms without departing from the supervisory trajectory-governance principles set forth in this specification. The appended claims define the scope of protection, and no limitation is intended by the specific implementations described herein. In the absence of such supervisory trajectory-governance configurations, complex systems may exhibit unbounded drift, instability across interacting variables, oscillatory behavior, or delayed and reactive-only correction under certain conditions.

In some embodiments, trajectory-governance functions may be implemented using a feedforward supervisory posture, which may represent a preferred or primary supervisory configuration in certain implementations, in which experiential signals and trajectory-state indicators are evaluated during formation or evolution of system behavior. In such embodiments, bounded modulation may be applied prior to realization of system outputs, allowing destabilizing trajectory divergence to be mitigated before observable outcomes occur. This feedforward configuration allows the system to modulate experiential trajectory direction while the interaction remains in progress, thereby reducing the likelihood of escalation, instability, or incoherent experiential states without requiring post-event correction.

In other embodiments, supervisory governance may operate using feedback-based or hybrid stabilization approaches in which previously realized outputs, observed experiential outcomes, or detected system responses inform subsequent modulation actions. Hybrid implementations may combine feedforward trajectory conditioning with feedback-informed adjustments, enabling supervisory governance across multiple temporal layers of the experiential process.

Various implementations may employ differing governance postures, including feedforward, feedback, hybrid supervisory, constraint-enforcement, threshold-triggered, or advisory-only configurations. In certain embodiments, the supervisory system may operate with modulation authority capable of influencing system outputs. In other embodiments, the supervisory layer may function in a monitoring or advisory capacity in which trajectory conditions are evaluated and stabilization recommendations are generated without directly altering system behavior. Variations in enforcement posture, modulation authority, or system integration level do not alter the underlying trajectory-governance architecture disclosed herein.

Additionally, the supervisory mechanisms described herein may be implemented with varying levels of architectural complexity. Certain embodiments may employ comprehensive trajectory modeling, multi-parameter drift evaluation, and layered stabilization logic, while other embodiments may utilize simplified supervisory cores or reduced evaluation mechanisms that preserve core trajectory modulation behavior. Such degraded, streamlined, or partially implemented configurations remain consistent with the supervisory trajectory-governance framework provided that the system evaluates experiential trajectory conditions and generates modulation responses capable of influencing downstream system behavior.

In certain embodiments, input signals may be derived from neural interface systems, including non-invasive or invasive brain-computer interface technologies configured to detect cognitive, emotional, or intent-related signals. Such signals may be interpreted as state conditions and processed by the Supervisory Modulation Framework (3000) without requiring direct control over the neural interface system and without dependence on the specific signal acquisition mechanism.

In certain embodiments, input signals may be derived from physiological or biometric sensing systems configured to detect indicators of user state, including cardiovascular activity, ocular tracking patterns, or other measurable physiological responses. Such signals may be interpreted as state conditions and processed within the Supervisory Modulation Framework (3000) independent of the sensing modality.

In certain embodiments, input signals may include environmental or contextual data generated by external systems or external entities, including ambient conditions or system state indicators associated with the interaction environment. Such signals may be incorporated as state conditions influencing trajectory evaluation and modulation without requiring modification to the core supervisory architecture.

In certain embodiments, input signals may originate from autonomous or semi-autonomous systems participating in the interaction process. These signals may be processed as state conditions within the Supervisory Modulation Framework (3000), enabling trajectory governance across interactions involving human and non-human system participants.

### Trajectory Governance Posture Variants

The supervisory trajectory-governance framework described herein may operate under a variety of governance postures depending on system policy, operational context, computational constraints, or integration with external systems.

In certain embodiments, the supervisory architecture may operate using a feedforward modulation posture, which may represent a preferred or primary supervisory configuration in certain implementations, in which experiential signals and trajectory indicators are evaluated during formation of system behavior. In such configurations, bounded modulation may be applied prior to output realization in order to modulate the evolving experiential trajectory before destabilizing divergence occurs.

In other embodiments, trajectory governance may operate using a feedback-based stabilization posture in which previously realized system outputs, observed experiential outcomes, or recorded trajectory states inform subsequent stabilization actions. Under such configurations, the supervisory layer may evaluate experiential drift after outputs have occurred and modulate subsequent system responses to guide the trajectory toward acceptable stability envelopes.

Hybrid governance embodiments may combine feedforward and feedback stabilization strategies across different temporal stages of system operation. Certain trajectory signals may trigger feedforward modulation during output formation, while additional trajectory assessments occurring after output realization may modulate subsequent system responses. Such hybrid governance models enable supervisory stabilization to occur both during experiential formation and across extended interaction sequences.

In certain embodiments, the supervisory architecture may operate through constraint-based governance mechanisms. In such implementations, trajectory conditions may be evaluated relative to predefined stability envelopes, anchor constraints, or threshold conditions, and modulation responses may be generated when trajectory indicators approach or exceed defined boundaries. These constraint-oriented embodiments allow stabilization behavior to occur selectively while preserving operational flexibility within acceptable trajectory regions.

Additional embodiments may implement advisory-mode supervisory layers in which trajectory monitoring and drift evaluation are performed without direct enforcement authority over downstream system behavior. In such configurations, the supervisory layer may generate stabilization recommendations, advisory signals, or governance guidance that may be consumed by other system components or policy layers responsible for implementing modulation actions. The absence of direct enforcement authority does not remove the presence of supervisory trajectory evaluation within the system architecture.

Certain embodiments may further employ simplified or partial trajectory-governance models, including reduced-anchor implementations, threshold-triggered monitoring systems, or lightweight supervisory cores that evaluate limited trajectory indicators while preserving core stabilization behavior. These streamlined configurations may operate with reduced computational overhead or limited enforcement scope while still performing trajectory evaluation and generating modulation responses capable of influencing experiential outcomes.

Accordingly, the supervisory trajectory-governance architecture disclosed herein encompasses a spectrum of governance postures ranging from passive monitoring and advisory guidance to supervisory control capable of influencing system behavior. Variations in enforcement authority, modulation timing, anchor utilization, or trajectory evaluation complexity do not depart from the disclosed architecture provided that the system performs evaluation of experiential trajectory conditions and generates modulation responses capable of influencing progression of system behavior over time. In the absence of such supervisory trajectory-governance postures, complex systems may exhibit unbounded drift, delayed or reactive-only correction behavior, instability across interacting variables, or inconsistent trajectory progression under certain conditions.

### Implementation Flexibility and Functional Equivalence

The supervisory trajectory-governance architecture described herein may be implemented using a variety of structural, computational, and software design paradigms without departing from the functional principles disclosed in this specification. Components illustrated in the figures as distinct systems, modules, processes, or signal paths represent functional roles within the architecture and may be realized using alternative structural arrangements or implementation mechanisms depending on platform constraints, deployment environments, or system design preferences.

Unless explicitly stated otherwise, any component described in this specification may be implemented as a system, process, engine, module, layer, pipeline, service, logic block, signal construct, data structure, or any combination thereof, provided that the implementation performs the stated function within the supervisory trajectory-governance architecture. The classification of a component in any figure or embodiment, including labels such as System, Process, Signal, External, or Visual, is illustrative and does not limit the structural realization of the disclosed components. Functional equivalence governs interpretation of these classifications, and implementations may vary across deployments without altering the intended supervisory behavior.

Functional responsibilities assigned to particular architectural elements may be consolidated, subdivided, or implemented using alternative computational abstractions while preserving the supervisory trajectory-governance behavior described herein. Accordingly, components illustrated as separate elements may in some implementations be combined into unified subsystems, while in other implementations a single illustrated component may be distributed across multiple processing stages, services, or computational structures without departing from the disclosed architecture.

Implementations of the supervisory trajectory-governance framework may vary with respect to system topology and deployment architecture. In certain embodiments, components may operate within a centralized processing environment. In other embodiments, functionality may be distributed across multiple services, nodes, or processing layers. Such implementations may include cloud-based deployments, edge-based processing environments, hybrid cloud-edge architectures, or distributed system configurations in which trajectory evaluation and modulation logic, or functionally equivalent analysis and influence mechanisms, operate across multiple computational boundaries.

The supervisory mechanisms described herein may further be implemented using a variety of computational infrastructure or acceleration technologies. Certain embodiments may employ hardware-accelerated processing, graphics processing unit (GPU) acceleration, field-programmable gate array (FPGA) implementations, or other specialized processing architectures. In other embodiments, the system may operate within virtualized computing environments, containerized service architectures, microservice frameworks, or other software orchestration platforms that provide scalable execution environments for trajectory evaluation and modulation functions.

Differences in implementation strategy, computational infrastructure, programming paradigm, or system topology do not alter the functional equivalence of the supervisory trajectory-governance architecture described herein. Implementations that perform evaluation of experiential trajectory conditions and generate modulation responses capable of influencing downstream system behavior remain consistent with the disclosed architecture regardless of whether those functions are implemented using monolithic applications, distributed services, modular software components, hardware-accelerated pipelines, or other computational structures.

Accordingly, the particular software architecture, deployment configuration, or computational platform used to realize the supervisory trajectory-governance functions described in this disclosure should not be interpreted as limiting the scope of the invention. The disclosed architecture encompasses functionally equivalent implementations that perform substantially similar trajectory evaluation and modulation behaviors using alternative structural or computational mechanisms. In the absence of such supervisory trajectory-governance implementations, systems operating under varying computational structures may exhibit inconsistent trajectory evaluation, degraded stability control, or reactive-only behavior under certain conditions.

### Component Classification Framework

For clarity and organizational consistency, components described in this specification and illustrated in the figures may be assigned to one of several classification categories. These categories are provided to assist interpretation of the architecture and to maintain consistency within the Authoritative Component Registry (ACR). The classification of a component within a particular category does not restrict implementation form and does not imply architectural rigidity or exclusivity of function.

System—a high-level functional grouping that may include coordinated processes, subsystems, control logic, or signal pathways responsible for performing supervisory trajectory-governance operations within the architecture.

Process—an operational unit that performs a defined transformation, evaluation, computation, decision operation, or routing task and may operate independently or as part of a larger System.

Signa—a logical output, event, communication pathway, or informational construct used to transmit trajectory indicators, evaluation results, or modulation directives between architectural elements.

External—any actor, platform, device, service, environment, or computational system that operates outside the supervisory trajectory-governance architecture but may interact with or provide inputs to the system.

Visual—a representational or illustrative construct used for depiction of system state, trajectory conditions, architectural relationships, or operational concepts and does not itself perform computational processing.

These classification categories are organizational constructs used to assist description of the architecture and should not be interpreted as limiting the structural realization or operational form of the disclosed components. A component identified within a particular category may be implemented using alternative computational structures or combined with other architectural elements provided that the functional behavior described in the specification is preserved.

### Descriptive Naming Conventions

As used throughout this disclosure, component names, labels, and reference identifiers are provided for organizational clarity and navigational convenience within the supervisory trajectory-governance architecture. The functional behavior, operational role, and system interactions of each component are defined by the accompanying description, figures, and contextual explanation rather than by the component name alone. Component names are not intended to imply limitation, exclusivity, or literal implementation unless expressly stated.

Component names may include descriptors such as engine, controller, layer, framework, module, mechanism, interface, router, analyzer, evaluator, generator, selector, monitor, processor, pipeline, and other similar terminology. These terms describe functional roles only and should not be interpreted as creating distinct architectural classifications or restricting implementation form. Each component remains interpreted according to its described functional behavior within the supervisory trajectory-governance architecture rather than according to the terminology used in its name.

### External System References

Certain systems, platforms, services, or actors referenced by name within this disclosure are external to the supervisory trajectory-governance architecture described herein and are included solely to illustrate interoperability, signal exchange, interaction context, or ecosystem participation. References to such external systems are provided for explanatory purposes and should not be interpreted as incorporating those systems into the disclosed architecture unless explicitly stated.

Unless expressly defined within this specification, external systems referenced in the figures or description are not characterized with respect to internal structure, functional behavior, operational logic, or implementation details. No limitation, inference, or claim scope implication regarding the internal operation of such external systems is intended.

Accordingly, references to third-party platforms, external services, computational environments, user systems, or ecosystem components should be understood as illustrative examples of environments in which the supervisory trajectory-governance architecture may operate or interact. The disclosed invention is independent of any particular external platform or service and may operate within a wide variety of system environments without departing from the principles described herein.

### Architectural Expression and Line-Style Neutrality

The architectural diagrams presented in the figures are intended to illustrate functional relationships between components of the supervisory trajectory-governance architecture rather than to prescribe specific physical layouts, processing hierarchies, or deployment arrangements. Components depicted in proximity to one another, enclosed within conceptual boundaries, or grouped within particular diagram regions are shown for explanatory clarity and should not be interpreted as imposing architectural restrictions on implementation.

Graphical conventions used throughout the figures, such as arrow directions, line styles, boundary outlines, diagram groupings, signal pathways, or visual formatting choices, are illustrative representations of logical relationships within the architecture. Such graphical elements are not intended to define specific communication protocols, data formats, execution order, or physical routing mechanisms unless expressly stated.

Variations in implementation structure, including consolidation or subdivision of components, centralization or distribution of logic, virtualization, hardware acceleration, or differences in routing conventions, are considered functionally equivalent for purposes of this specification. Differences in signal depiction, synchronous or asynchronous operation, supervisory signaling conventions, or diagrammatic formatting do not limit the scope of the disclosed supervisory trajectory-governance architecture.

Accordingly, the figures should be interpreted as conceptual representations of operational relationships among architectural elements rather than as literal physical system diagrams. Implementations may adopt alternative layout arrangements, communication pathways, or component organizations while preserving the functional trajectory-governance behavior described in this disclosure.

### Global Figure Standards and Drawing Conventions

All figures in this application follow a unified set of design conventions intended to maximize clarity, ensure reference-number consistency, and comply with USPTO drawing requirements under 37 C.F.R. § 1.84. These conventions apply to all figures unless explicitly stated otherwise.

Figures are rendered in black and white with consistent line weights suitable for USPTO reproduction. Component outlines use uniform stroke thickness, and all text appears in a legible sans-serif font. No color is used. Light grayscale may be employed only when required for interpretability or to distinguish adjacent regions without introducing shading inconsistencies, and such grayscale does not convey functional meaning.

Each component is identified by a unique reference number. When a component name appears in text, the reference number is shown in parentheses following the component name. In figures, reference numerals may appear alone or in proximity to component labels depending on space and legibility constraints. All reference numbers remain consistent across figures, appendices, and descriptive text to maintain architectural traceability.

Component classification within the figures follows the categories defined in this specification for organizational clarity only: System, Process, Signal, External, and Visual. Components are depicted using consistent visual containers for clarity, while classification distinctions are defined by the descriptive context of the specification and the legend presented in FIG. 1.

External Entity Convention. External actors, platforms, services, or environmental elements may appear outside the primary architectural boundary or outside the core system architecture boundary depicted in a figure. Such entities represent contextual inputs, outputs, or interoperability points and are not considered components of the claimed architecture unless explicitly stated otherwise.

Signal Line Styles. Signal lines follow standardized visual conventions for clarity of architectural relationships. Solid lines depict representative operational relationships or signal pathways between components. Where additional line styles are used in particular figures, such styles may illustrate representative supervisory influence paths, exception pathways, remediation flows, or other logical relationships. These visual conventions are illustrative only and do not define, limit, or require any particular signal type, execution sequence, or implementation mechanism.

Reference Number Consistency. All reference numerals are used consistently across figures, appendices, and descriptive text to maintain traceability and clarity within the supervisory trajectory-governance architecture.

Figure Legends. Overview figures may include legends identifying component containers, signal conventions, and architectural boundary indicators. The legend illustrated in FIG. 1 serves as the global legend for all figures unless a later figure provides an explicit supplemental legend for additional clarity.

### INDUSTRIAL APPLICABILITY

The SenseEcho supervisory trajectory-governance architecture is applicable to a wide range of real-world computing environments in which experiential states evolve dynamically during system interaction. Such environments may include, without limitation, interactive digital platforms, narrative-driven systems, communication infrastructures, simulation environments, or other computational systems in which user interactions, system responses, or contextual conditions produce evolving experiential states over time.

The disclosed architecture provides a deployable technical framework operating as a supervisory layer governing trajectory behavior, configured to evaluate experiential trajectory characteristics, detect deviation relative to defined anchor constraints, and apply bounded supervisory modulation capable of modulating system behavior during active interaction sequences. These supervisory functions may be applied across operational domains in which unmanaged experiential escalation, instability, or trajectory divergence may result in unbounded drift, inconsistent system behavior, oscillatory response patterns, or degraded operational outcomes under certain conditions.

In practical deployments, the SenseEcho supervisory architecture may be implemented within networked computing environments, cloud-based service platforms, distributed application infrastructures, simulation engines, conversational Al systems, or enterprise communication systems. The architecture operates using conventional computing resources including processors, memory systems, data storage components, communication interfaces, and secure execution environments, or functional equivalents thereof.

The architecture produces concrete technical effects including trajectory deviation detection, feedforward stabilization of experiential evolution, bounded modulation of system outputs, supervisory regulation of escalation dynamics, and structured coordination of interaction pacing. These effects improve operational stability and interaction coherence within systems in which experiential state evolution would otherwise be unmanaged or prone to destabilizing feedback dynamics.

The SenseEcho architecture is not limited to any single application domain. While certain embodiments may be described using narrative or interaction-oriented terminology for clarity, the supervisory framework is equally applicable to interactive media platforms, multiplayer environments, conversational Al systems, enterprise communication platforms, educational and training systems, simulation environments, and governance layers for intelligent software systems.

The disclosed supervisory trajectory-governance architecture is implemented through coordinated computational processes executed by one or more processors operating within a computing environment. The system processes experiential signal inputs to derive trajectory characteristics, determines supervisory modulation directives based on those characteristics, and transmits structured control signals through defined architectural pathways to influence system behavior during active interaction sequences, or generates advisory signals, monitoring outputs, or supervisory guidance without direct enforcement of modulation actions, depending on the implementation configuration. These operations are performed using computing components and produce measurable operational effects within the host system, including regulated modulation of interaction dynamics, controlled escalation behavior, and stabilized experiential trajectory progression during runtime system operation.

Accordingly, the SenseEcho invention is industrially applicable as a deployable supervisory control architecture capable of governing experiential trajectory evolution across diverse computational environments and producing measurable technical benefits when implemented within real-world interactive systems.

### ADVANTAGES OF THE INVENTION

The SenseEcho supervisory trajectory-governance architecture provides multiple technical and architectural advantages over conventional interactive systems that respond to experiential conditions after escalation or instability has manifested, which may result in delayed correction, unbounded drift, oscillatory response behavior, or degraded interaction stability under certain conditions. These advantages arise from the system's trajectory-oriented evaluation model, supervisory control architecture, and bounded modulation mechanisms rather than from any single algorithm, content format, or application domain.

One advantage of the disclosed architecture is its ability to evaluate experiential progression at the trajectory level rather than relying solely on instantaneous state measurements. By analyzing experiential signals over evolving interaction sequences, the system can detect emerging deviation patterns that indicate potential escalation or destabilization before those conditions fully manifest within the interaction environment.

Another advantage is the architecture's ability to perform early-stage escalation detection through supervisory trajectory evaluation. The system identifies indicators of experiential drift relative to defined trajectory anchors and can generate supervisory modulation directives prior to the activation of escalation thresholds. This feedforward posture enables stabilization-oriented intervention during earlier stages of experiential evolution.

The architecture further provides bounded modulation mechanisms that regulate how supervisory influence may be applied within operational environments. Rather than directly overriding system behavior or enforcing deterministic outcomes, supervisory modulation directives are transmitted through defined architectural pathways and applied within constrained operational boundaries, preserving system autonomy while still enabling trajectory conditioning.

An additional advantage is the architecture's ability to prevent experiential collapse within interactive environments. By identifying trajectory divergence and introducing stabilizing supervisory signals during active interaction sequences, the system reduces the likelihood of uncontrolled escalation dynamics that could otherwise degrade interaction coherence, destabilize narrative progression, or disrupt system continuity.

In certain implementations, supervisory modulation directives are applied for trajectory stabilization and continuity preservation rather than for engagement maximization, behavioral manipulation, or outcome optimization.

The SenseEcho architecture also provides supervisory governance that operates independently of platform-specific logic or application-layer implementation details. Because supervisory modulation signals are transmitted through defined architectural interfaces, the trajectory-governance framework can operate across diverse platforms and operational environments while maintaining consistent supervisory behavior.

Another advantage lies in the architecture's separation between trajectory evaluation, supervisory directive generation, and downstream execution environments. This separation enables supervisory governance to operate as a distinct control layer configured to evaluate experiential conditions and issue modulation directives without requiring direct integration with internal decision logic of external systems.

In certain implementations, supervisory trajectory evaluation may operate in a monitoring or advisory capacity in which trajectory conditions are assessed and stabilization guidance is generated without direct enforcement of modulation actions, thereby enabling supervisory influence in systems where direct control authority is not present.

Finally, the SenseEcho architecture supports extensibility across diverse interactive computing environments while maintaining consistent supervisory control principles. Because the system evaluates experiential trajectory characteristics and produces bounded modulation signals through defined architectural interfaces, the framework can be deployed across narrative systems, communication platforms, simulation environments, and other interactive infrastructures without requiring modification of the underlying trajectory-governance model.

Collectively, these advantages enable the SenseEcho supervisory trajectory-governance architecture to operate as a supervisory layer governing trajectory behavior within interactive computing environments by evaluating experiential trajectory evolution, detecting deviation relative to defined anchor constraints, and generating bounded supervisory modulation signals capable of modulating system behavior during active interaction sequences.

1-System A supervisory system configured to regulate an experiential trajectory of an interactive process, the system comprising:
one or more input interfaces configured to receive experiential signals associated with a progressing interaction;
a trajectory representation component configured to generate a trajectory representation based on the experiential signals;
a stability envelope model defining one or more acceptable bounds or constraints on the experiential trajectory over time;
a trajectory evaluation component configured to determine a deviation of the trajectory representation relative to the stability envelope;
a forward trajectory assessment component configured to determine a forward trajectory condition based on the trajectory representation and to identify a likelihood or condition indicating deviation relative to the stability envelope prior to realization of an interaction outcome;
a modulation directive generation component configured to generate a modulation directive based on the forward trajectory condition; and
a modulation interface configured to apply the modulation directive to the interactive process during progression of the interaction and prior to realization of an interaction outcome,
wherein the modulation directive is applied within one or more defined constraints as a bounded influence on progression of the experiential trajectory relative to the stability envelope without requiring modification of internal processing logic of the interactive process.

2-Context-Conditioned Stability Envelope The system of claim 1,
wherein the stability envelope model defines acceptable bounds that vary based on one or more experiential conditions associated with the interaction and are conditioned on one or more contextual or environmental conditions to adjust envelope parameters used in trajectory evaluation.

3-Multi-Dimensional Stability Envelope The system of claim 1,
wherein the stability envelope model defines acceptable bounds across a plurality of experiential dimensions of the experiential trajectory.

4-Constraint Enforcement Layer The system of claim 1,
wherein the system is configured to enforce the acceptable bounds or constraints of the stability envelope model by constraining application of the modulation directive to maintain progression of the experiential trajectory within the acceptable bounds or constraints.

5-Progressive Trajectory Evaluation The system of claim 1,
wherein the trajectory evaluation component is configured to evaluate the trajectory representation over time based on changes in the trajectory representation during the interaction.

6-Progression-Based Forward Assessment The system of claim 1,
wherein the forward trajectory assessment component is configured to determine the forward trajectory condition based on one or more trajectory progression characteristics associated with the trajectory representation.

7-Pre-Boundary Modulation Initiation The system of claim 1,
wherein the modulation directive is generated prior to reaching or at a boundary condition of the stability envelope based on the forward trajectory condition.

8-Post-Boundary Modulation Initiation The system of claim 1,
wherein the modulation directive is generated in response to or during deviation of the experiential trajectory relative to the stability envelope.

9-Bounded Non-Deterministic Modulation The system of claim 1,
wherein the modulation directive is applied within one or more constraints that limit influence on progression of the experiential trajectory without determining a resulting interaction outcome.

10-Variable Modulation Intensity The system of claim 1,
wherein the modulation directive varies in intensity or frequency based on the forward trajectory condition indicating deviation relative to the stability envelope.

11-Separation of Evaluation and Modulation Functions The system of claim 1,
wherein evaluation of the experiential trajectory and generation of the modulation directive are performed as separate functional processes such that modulation directive generation is based on the evaluation of the experiential trajectory and is not inherent within the evaluation of the experiential trajectory.

12-Supervisory Layer Independence The system of claim 1,
wherein the system operates as a supervisory control layer configured to influence the interactive process without requiring modification of internal processing logic of the system implementing the interactive process.

13-Interface-Based Modulation and Signal Exchange The system of claim 1,
wherein the modulation interface is configured to apply the modulation directive through one or more interfaces and the system is configured to exchange experiential signals and modulation directives with the interactive process through the one or more interfaces without requiring modification of internal processing logic of the interactive process.

14-Cross-Domain Deployment The system of claim 1,
wherein the modulation interface is configured to apply the modulation directive across one or more operational environments in which the interactive process is implemented.

15-Feedforward Trajectory Control The system of claim 1,
wherein the system is configured to apply the modulation directive based on the forward trajectory condition to influence progression of the experiential trajectory prior to deviation relative to the stability envelope.

16-Hybrid Trajectory Governance The system of claim 1, wherein the system is further configured to perform trajectory evaluation based on one or more previously observed trajectory conditions associated with the experiential trajectory in addition to the forward trajectory condition.

17-Advisory Modulation Mode The system of claim 1,
wherein the modulation directive comprises an advisory signal that influences the interactive process without requiring enforcement.

18-Reduced-Parameter Trajectory Evaluation The system of claim 1,
wherein the trajectory representation and the forward trajectory condition are determined based on a subset of experiential signals.

19-Trajectory-Based Supervisory Modulation Method A method of regulating an experiential trajectory of an interactive process, the method comprising:
receiving experiential signals associated with a progressing interaction;
generating a trajectory representation based on the experiential signals;
evaluating the trajectory representation relative to a stability envelope defining acceptable bounds or constraints on the experiential trajectory over time;
determining a forward trajectory condition based on the trajectory representation and identifying a likelihood or condition indicating deviation relative to the stability envelope prior to realization of an interaction outcome;
generating a modulation directive based on the forward trajectory condition; and
applying the modulation directive to the interactive process during progression of the interaction and prior to realization of an interaction outcome, wherein the modulation directive conditions progression of the experiential trajectory within the stability envelope without requiring modification of internal processing logic of the interactive process.

20-Non-Transitory Medium for Trajectory-Based Modulation A non-transitory computer-readable medium storing instructions that, when executed by one or more processors, cause a system to perform a method comprising:
receiving experiential signals associated with a progressing interaction;
generating a trajectory representation based on the experiential signals;
evaluating the trajectory representation relative to a stability envelope defining acceptable bounds or constraints on the experiential trajectory over time;
determining a forward trajectory condition based on the trajectory representation and identifying a likelihood or condition indicating deviation relative to the stability envelope prior to realization of an interaction outcome;
generating a modulation directive based on the forward trajectory condition; and
applying the modulation directive to an interactive process during progression of the interaction and prior to realization of an interaction outcome, wherein the modulation directive conditions progression of the experiential trajectory within the stability envelope without requiring modification of internal processing logic of the interactive process.
